(19) United States
(12) Patent Application Publication
(10) Pub. No.: US 2026/0338626 A1
(43) Pub. Date: Oct. 29, 2026

(54) METHOD AND APPARATUS FOR DETERMINING ROLLING FORCE IN CORRUGATED ROLLER ROLLING TECHNOLOGY AND DEVICE

(71) Applicant: TAIYUAN UNIVERSITY OF TECHNOLOGY, Taiyuan (CN)

(72) Inventors: Yuanming LIU, Taiyuan (CN); Jun SU, Taiyuan (CN); Dongping HE, Taiyuan (CN); Shiwu FENG, Taiyuan (CN); Zhenhua WANG, Taiyuan (CN); Xiaomiao NIU, Taiyuan (CN); Tao WANG, Taiyuan (CN); Qingxue HUANG, Taiyuan (CN)

(21) Appl. No.: 19/344,380

(22) Filed: Sep. 29, 2025

(30) Foreign Application Priority Data
Apr. 24, 2025 (CN) 202510521586.4

(51) Int. Cl. G01L 5/00

(52) U.S. Cl. CPC G01L 5/0061

(57) ABSTRACT

Disclosed are a method and apparatus for determining a rolling force in a corrugated roller rolling technology and a device. The method comprises the following steps of: acquiring technological parameters in a rolling process of a metal clad plate; based on a first neutral point and a second neutral point, dividing a deformation area of the metal clad plate to obtain a plurality of differential elements, and based on the technological parameters, determining critical information of each differential element; wherein the critical information comprises critical coordinates and shape parameters; and based on a type and the critical information of each differential element, determining and obtaining a rolling force per unit width corresponding to the deformation area by a differential equation of force equilibrium, and finally determining a rolling force in rolling of the metal clad plate by the corrugated roller.

### CROSS REFERENCE TO RELATED APPLICATIONS

This application claims foreign priority of Chinese Patent Application No. 202510521586.4, filed on Apr. 24, 2025 in the China National Intellectual Property Administration, the disclosures of all of which are hereby incorporated by reference.

### TECHNICAL FIELD

The present invention relates to the technical field of clad plate rolling, and particularly to a method and apparatus for determining a rolling force in a corrugated roller rolling technology and a device.

### BACKGROUND OF THE PRESENT INVENTION

Metal clad plate is a novel composite material formed by metallurgically combining two or more single metals firmly through a specific technology, which has many excellent properties. The metal clad plate can not only give full play to the advantages of each component, but also have many excellent comprehensive properties, such as better ductility, hardness and conductivity. Therefore, the metal clad plate is widely used in various fields, such as aerospace, ships and automobiles.

Preparation methods of the metal clad plate comprise a diffusion welding method, an extrusion and drawing method, an explosive bonding method, a casting-rolling bonding method and a rolling bonding method, wherein, the rolling bonding method is widely used because of high production efficiency and characteristic of easily realized industrial batch production.

A traditional flat roller rolling-bonding technology has the problems of excessively large bimetal elongation difference, low bonding strength and poor shape in a preparation process. In recent years, a corrugated rolling technology has been proposed, which has the advantages of shape improvement, grain refining and metal material anisotropy improvement. The corrugated rolling technology has been explained by related technologies. In a corrugated rolling process, the corrugated roller makes contact with a difficult-to-deform metal and the flat roller makes contact with an easy-to-deform metal, which solves the problems of uncoordinated metal deformation and the like, so as to obtain a metal clad plate with excellent performances.

In concrete implementation, before a rolling experiment, a roller gap between upper and lower rollers should be determined first, wherein a rolling force is a control core of a rolling mill, and by applying enough rolling force through the rolling mill, the metal can be deformed according to predetermined shape and size. At present, the rolling force in the corrugated rolling process is mainly predicted by a finite element method and an experimental method, but the finite element method takes a long time to calculate and the experimental method is expensive. Moreover, in these two methods, only one specific technology can be calculated and experimented at a time, which is time-consuming and inefficient. Therefore, a method for determining the rolling force with short calculation time, low cost and good flexibility is urgently needed in the corrugated rolling process.

### SUMMARY OF THE PRESENT INVENTION

The present invention aims to provide a method and apparatus for determining a rolling force in a corrugated roller rolling technology and a device for improving calculation efficiency and prediction accuracy of a rolling force in rolling of a metal clad plate by a corrugated roller.

In order to achieve the above objective, the present invention provides the following technical solutions.

In a first aspect, the present invention provides a method for determining a rolling force in a corrugated roller rolling technology, which comprises the following steps of:
acquiring technological parameters in a rolling process of a metal clad plate;
wherein the technological parameters comprise at least a width of the metal clad plate;
determining a first neutral point corresponding to a flat roller and a second neutral point corresponding to a corrugated roller;
based on the first neutral point and the second neutral point, dividing a deformation area of the metal clad plate to obtain a plurality of differential elements; wherein the deformation area is a clad plate area in which the metal clad plate makes contact with the flat roller and the metal clad plate makes contact with the corrugated roller;
based on the technological parameters, determining critical information of each differential element; wherein the critical information comprises critical coordinates and shape parameters;
based on a type and the critical information of each differential element, determining and obtaining a rolling force per unit width corresponding to the deformation area by a differential equation of force equilibrium; and
based on the rolling force per unit width and the width of the metal clad plate, determining a rolling force in rolling of the metal clad plate by the corrugated roller.

Optionally, before the step of, based on the type and the critical information of each differential element, determining and obtaining the rolling force per unit width corresponding to the deformation area by the differential equation of force equilibrium, the method further comprises:
when the differential element is located on a left side of the first neutral point and in a thickening state, determining the differential element as a first-type differential element;
when the differential element is located on a right side of the first neutral point and in the thickening state, determining the differential element as a second-type differential element;
when the differential element is located on the left side of the first neutral point and in a thinning state, determining the differential element as a third-type differential element; and
when the differential element is located on the right side of the first neutral point and in the thinning state, determining the differential element as a fourth-type differential element.

Optionally, the metal clad plate comprises a hard metal layer and a soft metal layer;
the step of, based on the type and the critical information of each differential element, determining and obtaining the rolling force per unit width corresponding to the deformation area by the differential equation of force equilibrium, comprises:
determining a first contact friction stress between the hard metal layer and the corrugated roller;
determining a second contact friction stress between the soft metal layer and the flat roller; and
determining a third contact friction stress between the hard metal layer and the soft metal layer;
according to the type of each differential element, based on the first contact friction stress, the second contact friction stress and the third contact friction stress, calculating and obtaining a first average shear stress corresponding to the hard metal layer in each differential element and a second average shear stress corresponding to the soft metal layer in each differential element;
based on the type of each differential element, substituting both of the first average shear stress and the second average shear stress corresponding to each differential element into the differential equation of force equilibrium, and according to a stress boundary condition and a yield condition, deriving and obtaining the rolling stress per unit width corresponding to the differential element; and
based on the critical information, performing integration and summation on rolling stresses per unit width of all differential elements in the deformation area to obtain the rolling force per unit width.

Optionally, the technological parameters further comprise a first friction coefficient, a second friction coefficient and a third friction coefficient;
the step of determining the first contact friction stress between the hard metal layer and the corrugated roller, comprises:
substituting the first friction coefficient into a formula:

f₁=2m₁*k₁
calculating and obtaining the first contact friction stress; wherein, f₁ is the first contact friction stress; and m is the first friction coefficient; the step of determining the second contact friction stress between the soft metal layer and the flat roller, comprises:
substituting the second friction coefficient into a formula:

f₂=2m₂*k₂
calculating and obtaining the second contact friction stress; wherein, f₂ is the second contact friction stress; and m₂ is the second friction coefficient; and
the step of determining the third contact friction stress between the hard metal layer and the soft metal layer, comprises:
substituting the third friction coefficient into a formula:

f₃=2m₃*kₑ
calculating and obtaining the third contact friction stress; wherein, f₃ is the third contact friction stress; and m₃ is the third friction coefficient;
wherein,

$${k}_{1} = \frac{{σ}_{y}}{\sqrt{3}} ;$$

$${k}_{2} = \frac{{σ}_{r}}{\sqrt{3}} ;$$

$${k}_{e} = \frac{{k}_{e i} + {k}_{e o}}{2} ;$$

$${k}_{e i} = \frac{{H}_{y}}{{H}_{y} + {H}_{r}} * {k}_{1} + \frac{{H}_{r}}{{H}_{y} + {H}_{r}} * {k}_{2}$$

$${k}_{e o} = \frac{{h}_{y}}{{h}_{y} + {h}_{r}} * {k}_{1} + \frac{{h}_{r}}{{h}_{y} + {h}_{r}} * {k}_{2}$$

σ_{y} is a deformation resistance of the hard metal layer; and σᵣ is a deformation resistance of the soft metal layer;
Hᵣ is an inlet thickness of the soft metal layer; and hᵣ is an outlet thickness of the soft metal layer; and
H_{y} is an inlet thickness of the hard metal layer; and h_{y} is an outlet thickness of the hard metal layer.

Optionally, the step of, according to the type of each differential element, based on the first contact friction stress, the second contact friction stress and the third contact friction stress, calculating and obtaining the first average shear stress corresponding to the hard metal layer in each differential element and the second average shear stress corresponding to the soft metal layer in each differential element, comprises:
as for the first-type differential element, substituting the first contact friction stress and the third contact friction stress into a formula:

$${τ}_{s 1} = \frac{{f}_{1} + {f}_{3}}{2}$$

calculating and obtaining the first average shear stress; wherein τₛ₁ is the first average shear stress;
as for the first-type differential element, substituting the second contact friction stress and the third contact friction stress into a formula:

$${τ}_{s 2} = \frac{{f}_{2} - {f}_{3}}{2}$$

calculating and obtaining the second average shear stress; wherein τₛ₂ is the second average shear stress;
as for the second-type differential element, substituting the first contact friction stress and the third contact friction stress into a formula:

$${τ}_{s 1} = \frac{{f}_{1} + {f}_{3}}{2}$$

calculating and obtaining the first average shear stress;
as for the second-type differential element, substituting the second contact friction stress and the third contact friction stress into a formula:

$${τ}_{s 2} \frac{{f}_{2} + {f}_{3}}{2}$$

calculating and obtaining the second average shear stress;
as for the third-type differential element, substituting the first contact friction stress and the third contact friction stress into a formula:

$${τ}_{s 1} \frac{{f}_{1} + {f}_{3}}{4}$$

calculating and obtaining the first average shear stress;
as for the third-type differential element, substituting the second contact friction stress and the third contact friction stress into a formula:

$${τ}_{s 2} \frac{{f}_{2} + {f}_{3}}{4}$$

calculating and obtaining the second average shear stress;
as for the fourth-type differential element, substituting the first contact friction stress and the third contact friction stress into a formula:

$${τ}_{s 1} \frac{{f}_{1} + {f}_{3}}{4}$$

calculating and obtaining the first average shear stress; and
as for the fourth-type differential element, substituting the second contact friction stress and the third contact friction stress into a formula:

$${τ}_{s 2} \frac{{f}_{2} + {f}_{3}}{2}$$

calculating and obtaining the second average shear stress.

Optionally, the technological parameters further comprise a length of a corrugated clad plate, an upper surface equation of the corrugated clad plate in contact with the corrugated roller and a lower surface equation of the corrugated clad plate in contact with the flat roller; and the corrugated clad plate is a rolled metal clad plate;
the upper surface equation is:

$$\{ \begin{matrix}{y}_{1} ( x ) = \frac{{h}_{o}}{2} - \frac{4 {λ}_{H}}{{λ}_{S}^{2}} ( x - ( i {λ}_{S} + \frac{{λ}_{S}}{2} ) ) ( x - ( i {λ}_{S} + {λ}_{S} ) ) , i ∈ Z , x ∈ [ i {λ}_{S} , i {λ}_{S} + \frac{{λ}_{S}}{2} ] \\ {y}_{2} ( x ) = \frac{{h}_{o}}{2} + \frac{4 {λ}_{H}}{{λ}_{S}^{2}} ( x - ( i {λ}_{S} + {λ}_{S} ) ) ( x - ( i {λ}_{S} + \frac{3 {λ}_{S}}{2} ) ) , i ∈ Z , x ∈ [ i {λ}_{S} + \frac{{λ}_{S}}{2} , ( i + 1 ) {λ}_{S} ]\end{matrix}$$

the lower surface equation is:

$${y}_{3} ( x ) = - \frac{{h}_{o}}{2} , x ∈ [ 0 , L ] ;$$

wherein, hₒ=h_{y}+hᵣ, L is the length of the corrugated clad plate; λ_{H} is an amplitude of corrugation in the corrugated roller, λ_{S} is a length of one cycle of corrugation in the corrugated roller; and Z represents a positive integer;
the method for determining the rolling force further comprises:
extracting and obtaining the amplitude of corrugation in the corrugated roller and the length of one cycle of corrugation in the corrugated roller from the upper surface equation.

Optionally, the technological parameters further comprise:
an equivalent rolling radius corresponding to the corrugated roller and the flat roller together;
the step of, based on the technological parameters, determining the critical information of each differential element, comprises:
substituting the equivalent rolling radius into a formula:

$${x}_{n} = ( R + {λ}_{H} ) * sin ( \frac{{n}^{π}}{M} )$$

calculating and obtaining a critical abscissa; wherein, xₙ is the critical abscissa; R is the equivalent rolling radius; M is a number of corrugations in the corrugated roller; and n represents an n^{th} differential element;
substituting the equivalent rolling radius into a formula:

$${y}_{n} = R + \frac{{h}_{0}}{2} - ( R \pm {λ}_{H} ) * sin ( \frac{{n}^{π}}{M} ) * cos ( \frac{{n}^{π}}{M} )$$

calculating and obtaining a critical ordinate; wherein, yₙ is the critical ordinate; and h₀ is an outlet thickness of the metal clad plate;
by adopting the following formula:

$${a}_{n} = \frac{{y}_{n + 1} - {y}_{n}}{{x}_{n + 1} - {x}_{n}}$$

calculating and obtaining a first shape parameter; wherein aₙ is the first shape parameter; and
by adopting the following formula:

bₙ=yₙ₊₁−aₙ*xₙ₊₁
calculating and obtaining a second shape parameter; wherein bₙ is the second shape parameter.

Optionally, the step of, based on the critical information, performing integration and summation on the rolling stresses per unit width of all differential elements in the deformation area to obtain the rolling force per unit width, comprises:
based on the critical information, by adopting the following formula:

$${P}^{′} = {\sum }_{n}^{U} {\int }_{{X}_{n}}^{{X}_{n + 1}} {P}_{n} ( x )$$

calculating and obtaining the rolling force per unit width; wherein, P is the rolling force per unit width; Pₙ(x) is a rolling stress per unit width of the n^{th} differential element; and U is a total number of differential elements.

Compared with the prior art, in the present invention, the technological parameters in the rolling process of the metal clad plate are acquired first; the technological parameters comprise at least the width of the metal clad plate, then, based on the first neutral point and the second neutral point, the deformation area of the metal clad plate is divided to obtain the plurality of differential elements, then, based on the technological parameters, the critical information of each differential element is determined, then, based on the type and the critical information of each differential element, the rolling force per unit width corresponding to the deformation area is determined and obtained by the differential equation of force equilibrium, and finally, based on the rolling force per unit width and the width of the metal clad plate, the rolling force in rolling of the metal clad plate by the corrugated roller is determined, wherein the obtained rolling force is highly consistent with an actual value. This prediction technology is not only safe and reliable, and accurate in calculation, but also easy to operate, has good programmability, and facilitates analyzing an influence rule of various rolling technological parameters on the rolling force.

In a second aspect, the present invention further provides an apparatus for determining a rolling force in a corrugated roller rolling technology, which comprises: an acquisition module configured for acquiring technological parameters in a rolling process of a metal clad plate; wherein the technological parameters comprise at least a width of the metal clad plate;
a first determination module configured for determining a first neutral point corresponding to a flat roller and a second neutral point corresponding to a corrugated roller;
a division module configured for, based on the first neutral point and the second neutral point, dividing a deformation area of the metal clad plate to obtain a plurality of differential elements; wherein the deformation area is a clad plate area in which the metal clad plate makes contact with the flat roller; a second determination module configured for, based on the technological parameters, determining critical information of each differential element; wherein the critical information comprises critical coordinates and shape parameters;
a third determination module configured for, based on a type and the critical information of each differential element, determining and obtaining a rolling force per unit width corresponding to the deformation area by a differential equation of force equilibrium; and
a fourth determination module configured for, based on the rolling force per unit width and the width of the metal clad plate, determining a rolling force in rolling of the metal clad plate by the corrugated roller.

In a third aspect, the present invention further provides an electronic device, which comprises a processor, a communication interface, a storage and a communication bus; wherein, the processor, the communication interface and the storage communicate through the communication bus; a computer program executable by the processor is stored in the storage; and when the computer program is operated in the processor, the method for determining the rolling force in the corrugated roller rolling technology above is executed.

### DESCRIPTION OF THE DRAWINGS

The drawings described herein are used for providing further understanding for the present invention, and constitute a part of the present invention. Exemplary embodiments of the present invention and the descriptions thereof are used for explaining the present invention, and do not constitute any inappropriate limitation to the present invention. In the drawings:

FIG. 1 is a flow chart of a method for determining a rolling force in a corrugated roller rolling technology provided by one embodiment of the present invention;

FIG. 2 is a first state diagram of a corrugated roller and a flat roller which jointly roll a metal clad plate provided by one embodiment of the present invention;

FIG. 3 is a schematic diagram of a coordinate system established according to the rolled metal clad plate provided by one embodiment of the present invention;

FIG. 4 is a second state diagram of the corrugated roller and the flat roller which jointly roll the metal clad plate provided by one embodiment of the present invention;

FIG. 5 is a schematic diagram of stress analysis of one differential element in FIG. 4 of the present invention;

FIG. 6 is a graph of a simulation result provided by one embodiment of the present invention;

FIG. 7 is a schematic structural diagram of an apparatus for determining a rolling force in a corrugated roller rolling technology provided by one embodiment of the present invention; and

FIG. 8 is a schematic structural diagram of an electronic device provided by one embodiment of the present invention.

### DETAILED DESCRIPTION OF PREFERRED EMBODIMENTS

In order to clearly describe technical solutions of embodiments of the present invention, in the embodiments of the present invention, the terms “first”, “second” and the like are used to distinguish the same or similar items with basically the same functions and effects. For example, a first threshold and a second threshold are only used for distinguishing different thresholds, and are not intended to limit a sequence. Those skilled in the art may understand that the terms “first”, “second” and the like are not intended to limit a quantity and an execution order, and the terms “first”, “second” and the like are not necessarily different.

It should be noted that, in the present invention, the term “exemplary” or “for example” is used to represent an example, an illustration or an explanation. Any embodiment or design scheme described as “exemplary” or “for example” in the present invention should not be interpreted as being more preferred or advantageous than other embodiments or design schemes. Specifically, the use of the term such as “exemplary” or “for example” aims to present a related concept in a concrete way.

In the present invention, “at least one” refers to being one or more, and “multiple” refers to being two or more. “And/or” describes a relationship between related objects, and indicates that there may be three relationships.

As shown in FIG. 1, an embodiment of the present invention provides a method for determining a rolling force in a corrugated roller rolling technology, which comprises the following steps.

In step 110, technological parameters in a rolling process of a metal clad plate are acquired; wherein the technological parameters comprise at least a width of the metal clad plate.

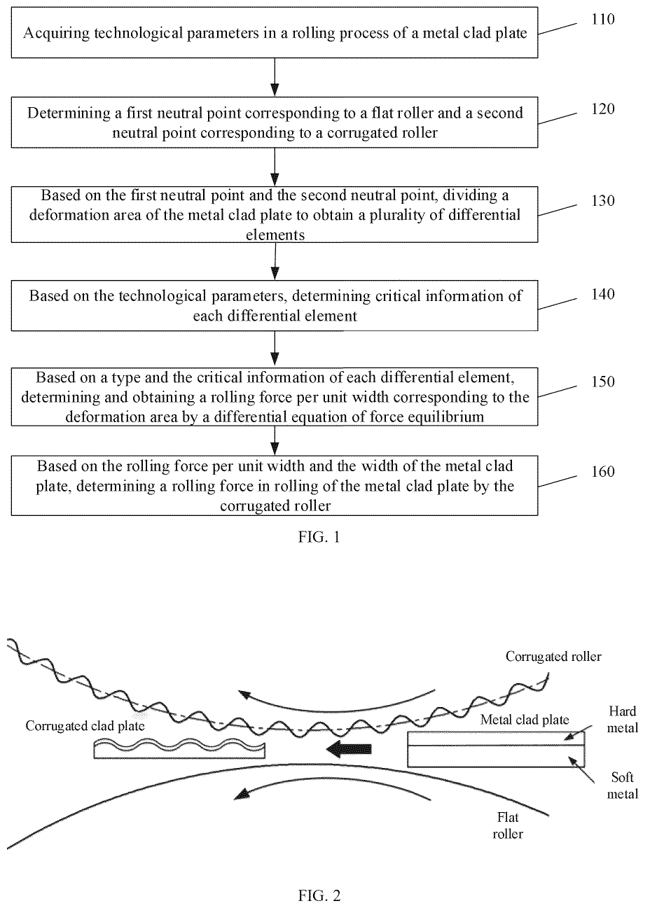

For example, as shown in FIG. 2, in the embodiment of the present invention, a corrugated clad plate is obtained by rolling the metal clad plate through a corrugated roller and a flat roller. The metal clad plate comprises two layers of metal, wherein one layer is a hard metal layer and the other layer is a soft metal layer. The hard metal layer is on one side of the corrugated roller, and the soft metal layer is on one side of the flat roller. For example, the hard metal layer is a copper plate, and the soft metal layer is an aluminum plate.

In concrete implementation, the whole rolling process comprises multiple passes of rolling, many technological parameters are acquired during each pass of rolling, and the width B of the metal clad plate is only one of the technological parameters. Other technological parameters comprise: an inlet thickness H_{y} of the hard metal layer, an inlet thickness Hᵣ of the soft metal layer, an outlet thickness h_{y} of the hard metal layer and an outlet thickness hᵣ of the soft metal layer in the metal clad plate, a forward tension t₀ of the metal clad plate, a backward tension tᵢ of the metal clad plate, a contact friction coefficient m between the hard metal layer and the corrugated roller, a friction coefficient m₂ between the soft metal layer and the flat roller, a friction coefficient m₃ between the hard metal layer and the soft metal layer, an equivalent rolling radius R of the corrugated roller, an equivalent rolling radius R of the flat roller, a contact equation between an upper surface of the corrugated clad plate and the corrugated roller, a contact equation between a lower surface of the corrugated clad plate and the flat roller, and the like. The equivalent rolling radius of the corrugated roller is the same as the equivalent rolling radius of the flat roller in size.

The inlet thickness of the hard metal layer, the inlet thickness of the soft metal layer and the width of the metal clad plate are usually determined in a material preparation stage before production, and may be acquired by direct measurement or according to material specifications.

The outlet thickness of the hard metal layer and the outlet thickness of the soft metal layer are usually calculated and obtained by a rolling theory (such as a rolling force formula and a spring equation) combined with experimental data.

As for the forward tension and the backward tension, the tension is usually set by a tension control system, and may be adjusted according to technological requirements. The existence of tension is conductive to improving a shape and reducing a rolling force in a rolling process.

The friction coefficient is influenced by material properties, roughness and lubrication conditions of a contact surface, and may be acquired by experimental measurement or consultation of relevant literatures.

The rolling radius is usually determined by a design size of the roller, and may be acquired by direct measurement or according to a design drawing.

The contact equation describes a geometric relationship between the plate and the roller in the rolling process. As for the corrugated roller, the contact equation may comprise parameters such as a form, cycle and amplitude of corrugation; and as for the flat roller, the contact equation is relatively simple, and usually only involves a length and angle of contact between the plate and the roller. These equations may be obtained by geometric analysis or numerical simulation.

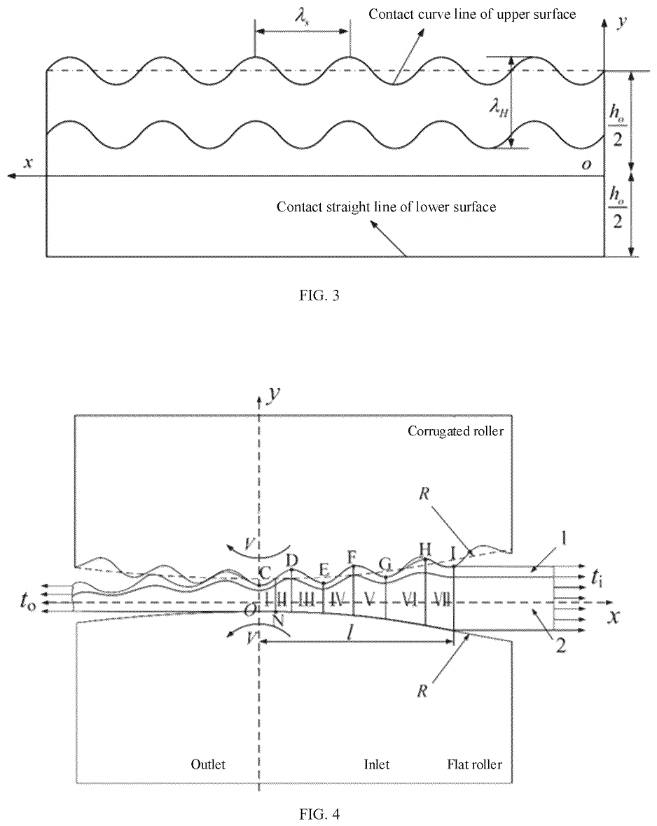

As shown in FIG. 3, a central horizontal line of an equivalent outlet thickness of the metal clad plate is taken as an x axis, a forward direction of the x axis is the same as a rolling direction, and in the rolling process, an equivalent outlet position comprises two positions: a front corrugation waist midpoint and a back corrugation waist midpoint. A common center line of the upper corrugated roller and the lower flat roller is taken as a y axis, a positive direction of the y axis is an upward direction, an intersection point of the two axes is an origin 0 of coordinates, and then a corresponding coordinate system is established, so that an upper surface equation of the corrugated clad plate in contact with the corrugated roller may be obtained as follows:

$$\{ \begin{matrix}{y}_{1} ( x ) = \frac{{h}_{o}}{2} - \frac{4 {λ}_{H}}{λ {s}^{2}} ( x - ( i {λ}_{S} + \frac{{λ}_{S}}{2} ) ) ( x - ( i {λ}_{S} + {λ}_{S} ) ) , i ∈ Z , x ∈ [ i {λ}_{S} , i {λ}_{S} + \frac{{λ}_{S}}{2} ] \\ {y}_{2} ( x ) = \frac{{h}_{o}}{2} + \frac{4 {λ}_{H}}{{λ}_{{S}^{2}}} ( x - ( i {λ}_{S} + {λ}_{S} ) ) ( x - ( i {λ}_{S} + \frac{3 {λ}_{S}}{2} ) ) , i ∈ Z , x ∈ [ i {λ}_{S} + \frac{{λ}_{S}}{2} , ( i + 1 ) {λ}_{S} ]\end{matrix} \qquad ( 1 )$$

wherein, a maximum value of x is L; and
a lower surface equation of the corrugated clad plate in contact with the flat roller is as follows:

$${y}_{3} ( x ) = - \frac{{h}_{o}}{2} , x ∈ [ 0 , L ] \qquad ( 2 )$$

wherein, hₒ is an outlet thickness of the metal clad plate, hₒ=h_{y}+hᵣ; L represents a length of the rolled metal clad plate (for example, the corrugated clad plate), λ_{H} represents an amplitude of corrugation in the corrugated roller, λ_{S} represents a length of one cycle of corrugation in the corrugated roller; and Z represents a positive integer.

After acquiring the upper surface equation and the lower surface equation, two parameters comprising the amplitude of corrugation in the corrugated roller and the length of one cycle of corrugation in the corrugated roller may be extracted and obtained from the upper surface equation for subsequent calculation of critical information.

In step 120, a first neutral point corresponding to the flat roller and a second neutral point corresponding to the corrugated roller are determined. A corrugation form state of the corrugated clad plate at an outlet position comprises four states: a corrugation trough, the front corrugation waist midpoint, a corrugation peak and the back corrugation waist midpoint. For example, as shown in FIG. 4, the corrugation form state of the corrugated clad plate at the outlet position is the corrugation trough.

It can be understood that the neutral point refers to a point where a pressure and deformation of a metal material between rollers achieve balance in the rolling process. At this point, a flow velocity of the material is equal to a linear velocity of the roller.

The neutral point of the corrugated roller is often on the corrugation peak and the corrugation trough, so that there are multiple second neutral points, such as a point C, a point D, a point E, a point F, a point G, a point H and a point I as shown in FIG. 4.

There is only one neutral point of the flat roller, that is, there is only one first neutral point, referring to a point N as shown in FIG. 4.

In step 130, based on the first neutral point and the second neutral point, a deformation area of the metal clad plate is divided to obtain a plurality of differential elements; wherein the deformation area is a clad plate area in which the metal clad plate makes contact with the flat roller and the metal clad plate makes contact with the corrugated roller.

Because there is only one first neutral point while there are multiple second neutral points, the deformation area is divided by straight lines emitted from corrugation peak positions and corrugation trough positions and parallel to a connecting line between centers of two rollers. It is worth noting that the differential element should be divided separately at the neutral point of the flat roller. With reference to FIG. 4, the point C, the point N, the point D, the point E, the point F, the point G, the point H and the point I divide the deformation area into seven differential elements I, II, III, IV, V, VI and VII.

It should be particularly noted that, because a position of the first neutral point is unknown at the beginning, that is, the position needs to be solved, it is necessary to assume the position of the first neutral point when programming a rolling force determination method in the corrugated roller rolling technology, and then specific coordinates of the first neutral point may be obtained by solution. Specifically, a solution process of the first neutral point may be as follows: it is assumed that the position of the first neutral point is between the point C and the point D first, and in this way, there are a total of seven differential elements I, II, III, IV, V, VI and VII after division.

In step 140, based on the technological parameters, critical information of each differential element is determined; wherein the critical information comprises critical coordinates and shape parameters.

The step 140 may specifically comprise a first step, a second step, a third step and a fourth step as follows:

It should be noted that, before the first step, the step 140 may further comprise that:
by adopting the following formula:

$$1 = \sqrt{\frac{( 2 R ) ( {H}_{y} + {H}_{r} - {h}_{y} - {h}_{r} )}{2}} \qquad ( 3 )$$

a length of the deformation area is calculated and obtained. After determining the length of the deformation area, position coordinates of the deformation area in the coordinate system are (1, 0).

In the first step, the equivalent rolling radius and the amplitude of corrugation in the corrugated roller are substituted into a formula:

$${x}_{n} = ( R + {λ}_{H} ) * sin ( \frac{{n}^{π}}{M} ) \qquad ( 4 )$$

a critical abscissa is calculated and obtained; wherein, xₙ is the critical abscissa; R is the equivalent rolling radius; λ_{H} is the amplitude of corrugation in the corrugated roller; M is a number of corrugations in the corrugated roller; and n represents an n^{th} differential element.

In the second step, the equivalent rolling radius, the amplitude of corrugation in the corrugated roller and the outlet thickness of the metal clad plate are substituted into a formula:

$${y}_{n} = R + \frac{{h}_{0}}{2} - ( R \pm {λ}_{H} ) * sin ( \frac{{n}^{π}}{N} ) * cos ( \frac{{n}^{π}}{N} ) \qquad ( 5 )$$

a critical ordinate is calculated and obtained; wherein, yₙ is the critical ordinate; and h₀ is the outlet thickness of the metal clad plate.

In the third step, by adopting the following formula:

$${a}_{n} = \frac{{y}_{n + 1} - {y}_{n}}{{x}_{n + 1} - {x}_{n}} \qquad ( 6 )$$

a first shape parameter is calculated and obtained; wherein aₙ is the first shape parameter.

In the fourth step, by adopting the following formula:

$${b}_{n} = {y}_{n + 1} - {a}_{n} * {x}_{n + 1} \qquad ( 7 )$$

a second shape parameter is calculated and obtained; wherein bₙ is the second shape parameter.

It can be understood that, referring to FIG. 4, one differential element comprises two critical lines, each critical line corresponds to one critical point, and then there are two position coordinates at left and right critical points. For example, when calculating the critical information of the first differential element, position coordinates at a left critical point are x_{c}=0,

$${y}_{c} = \frac{{h}_{0}}{2} ,$$

position coordinates at the right critical point are as shown in Formula (4) and Formula (5), and in this case, n=1, and so on. Position coordinates at a left critical point of the second differential element are the same as the position coordinates at the right critical point of the first differential element, and position coordinates at a right critical point of the second differential element are obtained by allowing n to be 2. The formula in the step 140 is used to calculate the coordinates at the right critical point.

In step 150, based on a type and the critical information of each differential element, a rolling force per unit width corresponding to the deformation area is determined and obtained by a differential equation of force equilibrium.

The type of each differential element is involved in the step 150, so that, before the step 150, the method further comprises that the type of the differential element is determined, and a specific type determination process is as follows: when the differential element is located on a left side of the first neutral point and in a thickening state, the differential element is determined as a first-type differential element;
when the differential element is located on a right side of the first neutral point and in the thickening state, the differential element is determined as a second-type differential element;
when the differential element is located on the left side of the first neutral point and in a thinning state, the differential element is determined as a third-type differential element; and
when the differential element is located on the right side of the first neutral point and in the thinning state, the differential element is determined as a fourth-type differential element.

In the step 150, after classifying each differential element, stress analysis is performed on each differential element to construct the differential equation of force equilibrium, then the constructed differential equation of force equilibrium is solved, and in combination with the critical information of each differential element, an analytical solution of the rolling force per unit width corresponding to each differential element in the deformation area is obtained.

Optionally, the step 150 may comprise a first determination step, a second determination step, a third determination step, an average shear stress calculation step, a unit width rolling stress calculation step and an integration and summation step, which are specifically as follows.

In the first determination step, a first contact friction stress between the hard metal layer and the corrugated roller is determined.

In the second determination step, a second contact friction stress between the soft metal layer and the flat roller is determined.

In the third determination step, a third contact friction stress between the hard metal layer and the soft metal layer is determined.

In the average shear stress calculation step, according to the type of each differential element, based on the first contact friction stress, the second contact friction stress and the third contact friction stress, a first average shear stress corresponding to the hard metal layer in each differential element and a second average shear stress corresponding to the soft metal layer in each differential element are calculated.

In the unit width rolling stress calculation step, based on the type of each differential element, both of the first average shear stress and the second average shear stress corresponding to each differential element are substituted into the differential equation of force equilibrium, and according to a stress boundary condition and a yield condition, the rolling stress per unit width corresponding to the differential element is derived and obtained.

It can be understood that the differential equation of force equilibrium is constructed on the basis of Newton's second law or principle of force equilibrium, which describes a relationship between an inner stress and an external force of an object. In the rolling process, this equation usually involves a force equilibrium in a vertical direction (for example, a rolling direction) and a horizontal direction (for example, a width direction). As for the rolling process per unit width, in order to simplify the problem, for example, only the force equilibrium in the vertical direction may be considered, which usually means a force equilibrium between a rolling force (or a pressure) and an inner stress of a material.

The stress boundary condition refers to a distribution or magnitude of a stress on a boundary of an object. In the rolling process, these conditions are usually determined by a contact stress, contact friction stress and other external forces between a roller and a rolled piece. As for rolling per unit width, it is necessary to know a vertical pressure distribution exerted by the roller on the rolled piece and a possible contact friction stress distribution. These boundary conditions will affect an inner stress distribution of the rolled piece.

In this embodiment, the stress boundary condition means that rolling stresses of two adjacent differential elements at an overlapping boundary are equal.

The yield condition refers to a condition that the material starts to undergo a plastic deformation when acted by an external force. In metal rolling, this condition is usually related to a yield strength of the material. When the rolling stress reaches or exceeds the yield strength of the material, the material will start to undergo the plastic deformation. Therefore, the yield condition is a key limiting condition for calculating the rolling stress.

In this embodiment, the yield condition means that the metal clad plate undergoes the plastic deformation when a pressure exerted by the roller reaches an equivalent shear stress yield force.

In the integration and summation step, based on the critical information, integration and summation are performed on rolling stresses per unit width of all differential elements in the deformation area to obtain the rolling force per unit width.

In the prior art, it is also necessary to construct the differential equation of force equilibrium when measuring the rolling force in rolling of the metal clad plate by the corrugated roller. However, in the prior art, only a friction stress and a contact pressure on the differential element in the deformation area are considered when constructing the differential equation of force equilibrium, without considering an average shear stress on a side surface of the differential element. Firstly, because an existing finite element method is used in the prior art, which has a very large calculation amount, if the average shear stress is added, the calculation amount is very large, the calculation is more complicated, and a calculation duration is longer; and secondly, no suitable algorithm has been created in the prior art, which may well integrate the average shear stress into the algorithm to realize the measurement of the rolling force in rolling of the metal clad plate by the corrugated roller.

Different from the prior art, in this embodiment, the average shear stress on the side surface of the differential element is considered in the differential equation of force equilibrium, and after the average shear stress is integrated, more careful and accurate stress analysis may be performed on the differential element, so that the finally obtained rolling force in rolling of the metal clad plate by the corrugated roller is also more accurate.

In this embodiment, the average shear stress may be considered in the differential equation of force equilibrium, because each differential element is classified in this embodiment. It is found by the inventor through creative studies that each differential element further comprises an upper metal layer and a lower metal layer, so that directions of friction forces on an upper surface and a lower surface of each differential element are different, then it can be known that the average shear stress on the side surface of each differential element is different, and the average shear stress on each layer of metal is solved respectively according to the position of each differential element.

In step 160, based on the rolling force per unit width and the width of the metal clad plate, the rolling force in rolling of the metal clad plate by the corrugated roller is determined.

Beneficial effects: in the embodiment of the present invention, the technological parameters in the rolling process of the metal clad plate are acquired first; the technological parameters comprise at least the width of the metal clad plate, then, based on the first neutral point and the second neutral point, the deformation area of the metal clad plate is divided to obtain the plurality of differential elements, then, based on the technological parameters, the critical information of each differential element is determined, then, based on the type and the critical information of each differential element, the rolling force per unit width corresponding to the deformation area is determined and obtained by the differential equation of force equilibrium, and finally, based on the rolling force per unit width and the width of the metal clad plate, the rolling force in rolling of the metal clad plate by the corrugated roller is determined. In this way, the obtained rolling force is more accurate.

Further, the differential element is classified, two average shear stresses corresponding to each differential element are calculated on the basis of the classification of the differential element, and then the two average shear stresses are substituted into the differential equation of force equilibrium for solution, so that the obtained rolling force is more accurate, and the algorithm is easy to realize in programming, which can increase a calculation velocity and then improve calculation efficiency.

In one optional embodiment, the first determination step of determining the first contact friction stress between the hard metal layer and the corrugated roller, may specifically comprise:

substituting the first friction coefficient into a formula:

f₁=2m₁*k₁ (8)
calculating and obtaining the first contact friction stress; wherein, f₁ is the first contact friction stress; m₁ is the first friction coefficient; and k₁ is the first share yield stress;
the second determination step of determining the second contact friction stress between the soft metal layer and the flat roller, may specifically comprise: substituting the second friction coefficient into a formula:

f₂−2m₂*k₂ (9)

calculating and obtaining the second contact friction stress; wherein, f₂ is the second contact friction stress; m₂ is the second friction coefficient; and k₂ is the second share yield stress; and
the third determination step of determining the third contact friction stress between the hard metal layer and the soft metal layer, may specifically comprise: substituting the third friction coefficient into a formula:

f₃−2m₃*kₑ (10)
calculating and obtaining the third contact friction stress; wherein, f₃ is the third contact friction stress; and m₃ is the third friction coefficient; wherein,

$${k}_{1} = \frac{{σ}_{y}}{\sqrt{3}} ; {k}_{2} = \frac{{σ}_{r}}{\sqrt{3}} ; {k}_{e} = \frac{{k}_{ei} + {k}_{eo}}{2} ; {k}_{ei} = \frac{{H}_{y}}{{H}_{y} + {H}_{r}} * {k}_{1} + \frac{{H}_{r}}{{H}_{y} + {H}_{r}} * {k}_{2} ; and$$

$${k}_{eo} = \frac{{h}_{y}}{{h}_{y} + {h}_{r}} * {k}_{1} + \frac{{h}_{r}}{{h}_{y} + {h}_{r}} * {k}_{2} ;$$

σ_{y} is a deformation resistance of the hard metal layer; and σᵣ is a deformation resistance of the soft metal layer;
Hᵣ is an inlet thickness of the soft metal layer; and hᵣ is an outlet thickness of the soft metal layer; H_{y} is an inlet thickness of the hard metal layer; and
h_{y} is an outlet thickness of the hard metal layer; and
kₑᵢ represents an inlet shear yield stress; and kₑₒ represents an outlet shear yield stress.

After obtaining the first contact friction stress, the second contact friction stress and the third contact friction stress, a first average shear stress corresponding to the hard metal layer in each differential element and a second average shear stress corresponding to the soft metal layer in each differential element are calculated by specific steps as follows:
1) as for the first-type differential element, that is, when the metal clad plate is in a left “thickening” state at the neutral point of the flat roller, substituting the first contact friction stress and the third contact friction stress into a formula:

$${τ}_{s 1} = \frac{{f}_{1} + {f}_{3}}{2} \qquad ( 11 )$$

calculating and obtaining the first average shear stress; wherein τₛ₁ is the first average shear stress;
as for the first-type differential element, substituting the second contact friction stress and the third contact friction stress into a formula:

$${τ}_{s 2} = \frac{{f}_{2} - {f}_{3}}{4} \qquad ( 12 )$$

calculating and obtaining the second average shear stress; wherein τₛ₂ is the second average shear stress;
2) as for the second-type differential element, that is, when the metal clad plate is in a right “thickening” state at the neutral point of the flat roller, substituting the first contact friction stress and the third contact friction stress into a formula:

$${τ}_{s 1} = \frac{{f}_{1} + {f}_{3}}{2} \qquad ( 13 )$$

calculating and obtaining the first average shear stress; and
as for the second-type differential element, substituting the second contact friction stress and the third contact friction stress into a formula:

$${τ}_{s 2} = \frac{{f}_{2} + {f}_{3}}{2} \qquad ( 14 )$$

calculating and obtaining the second average shear stress;
3) as for the third-type differential element, that is, when the metal clad plate is in a left “thinning” state at the neutral point of the flat roller, substituting the first contact friction stress and the third contact friction stress into a formula:

$${τ}_{s 1} = \frac{{f}_{1} - {f}_{3}}{4} \qquad ( 15 )$$

calculating and obtaining the first average shear stress; and
as for the third-type differential element, substituting the second contact friction stress and the third contact friction stress into a formula:

$${τ}_{s 2} = \frac{{f}_{2} - {f}_{3}}{4} \qquad ( 16 )$$

calculating and obtaining the second average shear stress; and
4) as for the fourth-type differential element, that is, when the metal clad plate is in a right “thinning” state at the neutral point of the flat roller, substituting the first contact friction stress and the third contact friction stress into a formula:

$${τ}_{s 1} = \frac{{f}_{1} - {f}_{3}}{4} \qquad ( 17 )$$

calculating and obtaining the first average shear stress; and
as for the fourth-type differential element, substituting the second contact friction stress and the third contact friction stress into a formula:

$${τ}_{s 2} = \frac{{f}_{2} + {f}_{3}}{2} \qquad ( 18 )$$

calculating and obtaining the second average shear stress.

When the differential element is the first-type differential element, both of the first average shear stress and the second average shear stress corresponding to the differential element are substituted into the differential equation of force equilibrium, and according to the stress boundary condition and the yield condition, the rolling stress per unit width corresponding to the differential element is derived and obtained as follows:

$${P}_{n} ( x ) = k + \frac{[ - {f}_{2} - {f}_{1} ( 1 + {a}_{n}^{2} ) ] ( \frac{{x}^{3}}{6 R} + \frac{{a}_{n} {x}^{2}}{2} + {b}_{n} x + \frac{{h}_{0} x}{2} ) - {f}_{2} ( \frac{{x}^{5}}{10 {R}^{3}} + \frac{{a}_{n} {x}^{2}}{4 {R}^{2}} + \frac{{b}_{n} {x}^{3}}{3 {R}^{2}} + \frac{{h}_{0} {x}^{3}}{6 {R}^{2}} )}{{( {a}_{n} + {b}_{n} x + \frac{{x}^{2}}{2 R} + \frac{{h}_{0}}{2} )}^{2}} - \frac{{τ}_{s 2} ( 1 - \frac{{h}_{y}}{{h}_{0}} ) ( \frac{{a}_{n}^{2} {x}^{3}}{3 R} + \frac{{a}_{n} {b}_{n} {x}^{2}}{2 R} + \frac{{a}_{n} {x}^{4}}{8 {R}^{2}} + \frac{{a}_{n} {h}_{0} {x}^{2}}{4 R} + \frac{{a}_{n} {x}^{4}}{4 {R}^{2}} + \frac{{b}_{n} {x}^{3}}{3 {R}^{2}} + \frac{{h}_{0} {x}^{3}}{6 {R}^{2}} )}{{( {a}_{n} + {b}_{n} x + \frac{{x}^{2}}{2 R} + \frac{{h}_{0}}{2} )}^{2}} + \frac{{τ}_{s 1} \frac{{h}_{y}}{{h}_{0}} ( \frac{{a}_{n} {x}^{4}}{8 {R}^{2}} + \frac{{a}_{n}^{2} {x}^{3}}{6 R} + \frac{{a}_{n}^{3} {x}^{3}}{3 R} + \frac{{a}_{n}^{4} {x}^{3}}{4 {R}^{2}} + \frac{{a}_{n} {h}_{0} x}{4 R} + {a}_{n}^{2} {b}_{n} x + \frac{{a}_{n}^{2} {h}_{0} x}{2} ) + {C}_{n}}{{( {a}_{n} + {b}_{n} x + \frac{{x}^{2}}{2 R} + \frac{{h}_{0}}{2} )}^{2}} \qquad ( 19 )$$

wherein, Pₙ(x) is the rolling stress per unit width; h₀=h_{y}+hᵣ; k is a shear yield stress of the differential element; when the differential element is in an outlet area, k=kₑₒ; when the differential element is in an inlet area, k=kₑᵢ; when the differential element is in a middle area, k=kₑ; and Cₙ is an integration constant, and Cₙ may be obtained by solving a stress boundary of adjacent differential elements.

When the differential element is the second-type differential element, both of the first average shear stress and the second average shear stress corresponding to the differential element are substituted into the differential equation of force equilibrium, and according to the stress boundary condition and the yield condition, the rolling stress per unit width corresponding to the differential element is derived and obtained as follows:

$${P}_{n} ( x ) = k + \frac{[ {f}_{2} - {f}_{1} ( 1 + {a}_{n}^{2} ) ] ( \frac{{x}^{3}}{6 R} + \frac{{a}_{n} {x}^{2}}{2} + {b}_{n} x + \frac{{h}_{0} x}{2} ) + {f}_{2} ( \frac{{x}^{5}}{10 {R}^{3}} + \frac{{a}_{n} {x}^{4}}{4 {R}^{2}} + \frac{{b}_{n} {x}^{3}}{3 {R}^{2}} + \frac{{h}_{0} {x}^{3}}{6 {R}^{2}} )}{{( {a}_{n} + {b}_{n} x + \frac{{x}^{2}}{2 R} + \frac{{h}_{0}}{2} )}^{2}} - \frac{{τ}_{s 2} ( 1 - \frac{{h}_{y}}{{h}_{0}} ) ( \frac{{a}_{n}^{2} {x}^{3}}{3 R} + \frac{{a}_{n} {b}_{n} {x}^{2}}{2 R} + \frac{{a}_{n} {x}^{4}}{8 {R}^{2}} + \frac{{a}_{n} {h}_{0} {x}^{2}}{4 R} + \frac{{a}_{n} {x}^{4}}{4 {R}^{2}} + \frac{{b}_{n} {x}^{3}}{3 {R}^{2}} + \frac{{h}_{0} {x}^{3}}{6 {R}^{2}} ) + {C}_{n}}{{( {a}_{n} + {b}_{n} x + \frac{{x}^{2}}{2 R} + \frac{{h}_{0}}{2} )}^{2}} + {B}_{n} \qquad ( 20 )$$

### in Formula (20),

$${B}_{n} = \frac{{τ}_{s 1} {h}_{y} {a}_{n}}{2 {h}_{0}} .$$

When the differential element is the third-type differential element, both of the first average shear stress and the second average shear stress corresponding to the differential element are substituted into the differential equation of force equilibrium, and according to the stress boundary condition and the yield condition, the rolling stress per unit width corresponding to the differential element is derived and obtained as follows:

$${P}_{n} ( x ) = {D}_{n} x + {B}_{n} ln \vert {x}^{2} + 2 {Ra}_{n} x + 2 {Rb}_{n} + {Rh}_{0} \vert + \frac{{F}_{n}}{{G}_{n}} ln \vert \frac{x + {Ra}_{n} - {G}_{n}}{x + {Ra}_{n} + {G}_{n}} \vert - 2 {a}_{n} [ {f}_{2} - ( 1 - \frac{{h}_{y}}{{h}_{0}} ) {τ}_{s 2} ] + {C}_{n} \qquad ( 21 )$$

### in Formula (21),

$${D}_{n} = \frac{2 [ {f}_{2} + ( 1 - \frac{{h}_{y}}{{h}_{0}} ) {τ}_{s 2} ]}{R} ; {E}_{n} = 2 k - 2 {a}_{n} {f}_{2} - {a}_{n} [ ( 1 - \frac{{h}_{y}}{{h}_{0}} ) {τ}_{s 2} - {τ}_{s 1} \frac{{h}_{y}}{{h}_{0}} ] ;$$

and

Fₙ=[DₙR(Raₙ²−2bₙ−hₒ)+2R(f₂−f₁)(aₙ²+1)]/2;

Gₙ=\sqrt{R(Raₙ²−2bₙ−h₀)}.

When the differential element is the fourth-type differential element, both of the first average shear stress and the second average shear stress corresponding to the differential element are substituted into the differential equation of force equilibrium, and according to the stress boundary condition and the yield condition, the rolling stress per unit width corresponding to the differential element is derived and obtained as follows:

$${P}_{n} ( x ) = {H}_{n} x + {J}_{n} ln \vert {x}^{2} + 2 {Ra}_{n} x + 2 {Rb}_{n} + {Rh}_{0} \vert + \frac{{L}_{n}}{{G}_{n}} ln \vert \frac{x + {Ra}_{n} - {G}_{n}}{x + {Ra}_{n} + {G}_{n}} \vert - 2 {a}_{n} [ {f}_{2} - ( 1 - \frac{{h}_{y}}{{h}_{o}} ) {τ}_{s 2} ] + {C}_{n} \qquad ( 22 )$$

### in Formula (22),

$${H}_{n} - \frac{2 [ {f}_{2} + ( 1 - \frac{{h}_{y}}{{h}_{o}} ) {τ}_{s 2} ]}{R} ; {J}_{n} = 2 k - 2 {a}_{n} {f}_{2} - {a}_{n} [ {τ}_{s 2} ( 1 - \frac{{h}_{y}}{{h}_{o}} ) + {τ}_{s 1} \frac{{h}_{y}}{{h}_{o}} ] ; and$$

$${L}_{n} = \frac{[ {H}_{n} R ( {Ra}_{n}^{2} - 2 {b}_{n} - {h}_{o} ) + 2 R ( {f}_{2} + {f}_{1} ) ( {a}_{n}^{2} + 1 ) ]}{2} .$$

Subsequently, based on the critical information, by adopting the following formula:

$${P}^{′} = {\sum }_{n}^{U} {\int }_{{x}_{n}}^{{x}_{n + 1}} {P}_{n} ( x ) \qquad ( 23 )$$

the rolling force per unit width is calculated and obtained; wherein, Pₜₒₜₐₗ is the rolling force per unit width. A value range of n is [1, U], and U is a total number of differential elements.

Finally, according to the formula:

P_{target}=B×P′ (24)

the rolling force of the whole deformation area is calculated and obtained; wherein, P_{target} is the rolling force of the whole deformation area.

It can be seen from the above that the embodiment of the present invention provides a method for accurately predicting the rolling force in rolling of the metal clad plate by the corrugated roller, and the obtained rolling force is highly consistent with an actual value. This prediction technology is not only safe and reliable, and accurate in calculation, but also easy to operate, has good programmability, and facilitates analyzing an influence rule of various rolling technological parameters on the rolling force. In addition, this method does not limit the type of the metal material, may be widely used to predict rolling forces in corrugated rolling processes of various metal clad plates, and can save production investment costs, so that the products are better applied to practical production.

Specific description is made hereinafter with reference to the first specific embodiment.

In the first specific embodiment, the hard metal layer in the metal clad plate is a copper plate and the soft metal layer is an aluminum plate. The acquired technological parameters are as follows:

an inlet thickness of the copper plate is H_{y}=1 mm; an inlet thickness of the aluminum plate is Hᵣ=4 mm; the width of the metal clad plate is B=50 mm; an outlet thickness of the copper plate is h_{y}=0.802 mm; an outlet thickness of the aluminum plate is hᵣ=1.698 mm; the forward tension of the metal clad plat is tₒ=0e; the backward tension of the metal clad plate is tᵢ=0; a contact friction coefficient between the copper plate and the corrugated roller is m₁=0.325; a friction coefficient between the aluminum plate and the flat roller is m₂=0.4; a friction coefficient between the copper plate and the aluminum plate is m₃=0.25; the equivalent rolling radius of the corrugated roller and the equivalent rolling radius of the flat roller are R=75 mm; the amplitude of corrugation in the corrugated roller is λ_{H}=0.55 mm, and the length of one cycle of corrugation in the corrugated roller is λ_{S}=4.712 mm; σ_{y}=266.42 MPa; and σᵣ=181.98 MPa. With reference to FIG. 4, the deformation area is divided based on one first neutral point on the flat roller and multiple second neutral points on the corrugated roller to obtain a total of seven differential elements I, II, III, IV, V, VI and VII.

An abscissa xₙ and an ordinate yₙ of a critical point of each differential element are determined according to the above Formula (4) and Formula (5) as follows:

x_{C}=0, y_{C}=0.706; x_{D}=2.3, y_{D}=1.842; x_{E}=4.7, y_{E}=0.855; x_{F}=7, y_{F}=2.1; x_{G}=9.5, y_{G}=1.3; x_{H}=11.6, y_{H}=2.7; and x_{I}=14.2, y_{I}=2.

Then, a shape parameter of each differential element is calculated according to Formula (6) and Formula (7) as follows:

$${a}_{1} = \frac{{y}_{D} - {y}_{C}}{{x}_{D} - {x}_{C}} = 0.4939 , {b}_{1} = {y}_{D} - {a}_{1} {x}_{D} = 0.706 ; {a}_{2} = {a}_{1} = 0.4939 , {b}_{2} = {b}_{1} = 0.706 ;$$

$${a}_{3} = \frac{{y}_{E} - {y}_{D}}{{x}_{E} - {x}_{D}} = - 04113 , {b}_{3} = {y}_{E} - {a}_{3} {x}_{E} = 2.7881 ; {a}_{4} = \frac{{y}_{F} - {y}_{E}}{{x}_{F} - {x}_{E}} = 0.5413 , {b}_{4} = {y}_{F} - {a}_{4} {x}_{F} = - 1.6891 ;$$

$${a}_{5} = \frac{{y}_{G} - {y}_{F}}{{x}_{G} - {x}_{F}} = - 0.32 , {b}_{5} = {y}_{G} - {a}_{5} {x}_{G} = 4.34 ; {a}_{6} = \frac{{y}_{H} - {y}_{G}}{{x}_{H} - {x}_{G}} = 06667 , {b}_{6} = {y}_{H} - {a}_{6} {x}_{H} = - 5 \text{.0336} ; and$$

$${a}_{7} = \frac{{y}_{I} - {y}_{H}}{{x}_{I} - {x}_{H}} = - 0.2692 , {b}_{7} = {y}_{I} - {a}_{7} {x}_{I} = 5.8227 .$$

Based on a relative position relationship between each differential element and the first neutral point and a state of each differential element itself, the above 7 differential elements are classified into four types: the first-type differential element (the differential element is located on the left side of the first neutral point and in the thickening state), the second-type differential element (the differential element is located on the right side of the first neutral point and in the thickening state), the third-type differential element (the differential element is located on the left side of the first neutral point and in the thinning state) and the fourth-type differential element (the differential element is located on the right side of the first neutral point and in the thinning state). It should be emphasized that the first neutral point is a neutral point corresponding to the flat roller, and there is only one neutral point corresponding to the flat roller.

With reference to FIG. 4, it can be seen that the copper/aluminum corrugated clad plate (the differential element is referred to as an area for short hereinafter) in FIG. 4 comprises 3 second-type differential elements (the differential element is located on the right side of the first neutral point and in the thickening state), 3 fourth-type differential elements (the differential element is located on the right side of the first neutral point and in the thinning state) third-type differential element (the differential element is located on the left side of the first neutral point and in the thinning state).

It is calculated and obtained according to the technological parameters that:

$${k}_{1} = \frac{{σ}_{y}}{\sqrt{3}} = \frac{266.42}{\sqrt{3}} = 153.82 MPa ; {k}_{2} = \frac{{σ}_{r}}{\sqrt{3}} = \frac{181.98}{\sqrt{3}} = 105.07 MPa ;$$

$${k}_{e} = \frac{{k}_{ei} + {k}_{eo}}{2} = \frac{( \frac{{H}_{y}}{{H}_{r} + {H}_{y}} {k}_{1} + \frac{{H}_{r}}{{H}_{r} + {H}_{y}} {k}_{2} + \frac{{h}_{y}}{{h}_{r} + {h}_{y}} {k}_{1} + \frac{{h}_{r}}{{h}_{r} + {h}_{y}} {k}_{2} )}{2} = \frac{( \frac{1}{4 + 1} \times 153.82 + \frac{4}{4 + 1} \times 105.07 + \frac{0.802}{1.698 + 0.802} \times 153.82 + \frac{1.698}{1698 + 0.802} \times 105.07 )}{2}$$

$$= 117.73 MPa .$$

f₁=2m₁k₁=2×0.325×153.82=99.98 MPa; f₂=2m₂k₂=2×0.4×105.07=84.05 MPa; and f₃=2m₃kₑ=2×0.25×117.73=58.86 MPa.

Different types of differential elements have different average shear stresses on side surfaces because of different friction directions on upper and lower surfaces, and according to positions of the differential elements, a specific method for calculating average shear stresses on side surfaces of the copper plate and the aluminum plate is as follows:
when the copper/aluminum metal clad plate is located on the right side of the neutral point of the flat roller and in the “thickening” state, that is, when the differential element is the second-type differential element, an average shear stress on a side surface of an upper copper plate of the differential element is

$${τ}_{s 1} = \frac{( {f}_{1} + {f}_{3} )}{2} = 79.42 MPa ;$$

and an average shear stress on a side surface of a lower aluminum plate of the differential element is

$${τ}_{s 2} = \frac{( {f}_{2} + {f}_{3} )}{2} = 71.46 MPa ;$$

when the copper/aluminum metal clad plate is located on the left side of the neutral point of the flat roller and in the “thinning” state, that is, when the differential element is the third-type differential element, an average shear stress on a side surface of an upper copper plate of the differential element is

$${τ}_{s 1} = \frac{( {f}_{1} - {f}_{3} )}{4} = 10.28 MPa ;$$

and an average shear stress on a side surface of a lower aluminum plate of the differential element is

$${τ}_{s 2} = \frac{( {f}_{2} - {f}_{3} )}{4} = 6.29 MPa ;$$

and
when the copper/aluminum metal clad plate is located on the right side of the neutral point of the flat roller and in the “thinning” state, that is, when the differential element is the fourth-type differential element, an average shear stress on a side surface of an upper copper plate of the differential element is

$${τ}_{s 1} = \frac{( {f}_{1} - {f}_{3} )}{4} = 10.28 MPa ;$$

and an average shear stress on a side surface of a lower aluminum plate of the differential element is

$${τ}_{s 2} = \frac{( {f}_{2} + {f}_{3} )}{2} = 71.46 MPa .$$

In the first specific embodiment, with reference to FIG. 4, the deformation area of the copper/aluminum metal clad plate is divided into elements I, II, III, IV, V, VI and VII, and according to the differential equation of force equilibrium, the stress boundary condition and the yield condition, the rolling stress Pₙ(x) per unit width of each differential element is calculated as follows:

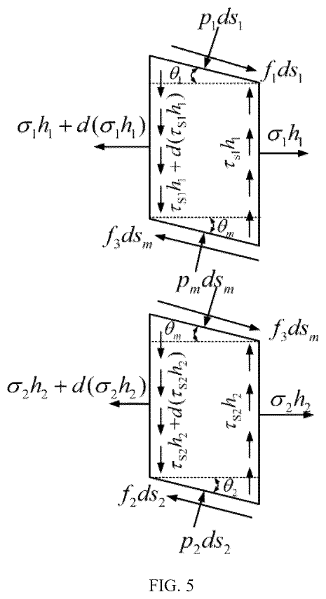

Taking the differential element VII as an example, a stress analysis process of the differential element is illustrated. The differential element VII is the second-type differential element (the differential element is located on the right side of the first neutral point and in the thickening state). A stress state of the differential element VII is as shown in FIG. 5, and it is known that friction stresses on upper and lower surfaces of the differential element VII are f₁ and f₂ respectively, and a friction stress on a bonding surface is f₃. An average shear stress of an upper metal layer may be calculated and obtained according to Formula (13)

$${τ}_{s 1} = \frac{{f}_{1} + {f}_{3}}{2} ,$$

and an average shear stress of a lower metal layer may be calculated and obtained according to Formula (14)

$${τ}_{s 2} = \frac{{f}_{2} + {f}_{3}}{2} .$$

According to stress analysis on the differential element perpendicular to a rolling direction, differential equations of horizontal and vertical force equilibriums of the upper and lower metal layers may be obtained as shown in Formula (25) and Formula (26) respectively.

$$\frac{d ( {σ}_{1} {h}_{1} )}{dx} + {p}_{1} tan {θ}_{1} - {f}_{1} - {p}_{m} tan {θ}_{m} + {f}_{3} = 0 \qquad ( 25 )$$

$$\frac{d ( {σ}_{2} {h}_{2} )}{dx} - {p}_{2} tan {θ}_{2} + {f}_{2} + {p}_{m} tan {θ}_{m} - {f}_{3} = 0 \qquad ( 26 )$$

P is solved, P is obtained after combining Formula (25) with Formula (26), and

$$P = {p}_{1} + {f}_{1} tan {θ}_{1} + {τ}_{s 1} \frac{{dh}_{1}}{dx} = {p}_{m} + {f}_{3} tan {θ}_{m} ; and P = {p}_{2} + {f}_{2} tan {θ}_{2} - {τ}_{s 2} \frac{{dh}_{2}}{dx} = {p}_{m} + {f}_{3} tan {θ}_{m} ;$$

wherein,
P represents a rolling pressure synthesized by a contact pressure and a friction stress, in a unit of Pa;
θ₁ represents a contact angle between an upper surface of the copper layer and a surface of the corrugated roller;
θ₂ represents a contact angle between a lower surface of the aluminum layer and a surface of the flat roller; and
θₘ represents a contact angle between a lower surface of the copper layer and an upper surface of the aluminum layer.

Considering that σ₁h₁+σ₂h₂=σh, wherein h represents a height of the differential element in the deformation area, according to a yield criterion p+σ=2kₑᵢ, a differential equation of rolling pressure between rollers of the differential element VII may be obtained by combining Formula (25) with Formula (26) as shown in Formula (27). Formula (27) may be called the differential equation of rolling pressure:

$$\frac{dp}{dx} = [ \begin{matrix}2 ( {k}_{ei} - p ) ( tan {θ}_{2} - tan {θ}_{1} ) - {f}_{1} ( tan {θ}_{1}^{2} + 1 ) + \\ {f}_{2} ( tan {θ}_{2}^{2} + 1 ) - \\ {τ}_{s 1} \frac{{dh}_{1}}{dx} tan {θ}_{1} - {τ}_{s 2} \frac{{dh}_{2}}{dx} tan {θ}_{2}\end{matrix} ] / h \qquad ( 27 )$$

in Formula (27), tan θ₁=−a₇;

$$tan {θ}_{2} = \frac{x}{R} , h = {a}_{7} x + {b}_{7} + \frac{1}{2} ( \frac{{x}^{2}}{R} + {h}_{o} ) ; \frac{{dh}_{1}}{dx} = {β}_{o} \frac{dh}{dx} ; \frac{{dh}_{1}}{dx} = ( 1 - {β}_{o} ) \frac{dh}{dx} ;$$

and βᵢ represents a thickness ratio of the copper plate to the aluminum plate at the inlet position βᵢ=H_{y}/Hᵣ; and
βₒ represents a thickness ratio of the copper plate to the aluminum plate at the outlet position, βₒ=h_{y}/hᵣ.

Therefore, the differential equation of Formula (27) undergoes integration solution to obtain a rolling stress distribution P₇(x) between rollers of the differential element VII as shown in Formula (28):

$${P}_{7} ( x ) = {k}_{ei} + \frac{[ {f}_{2} - {f}_{1} ( 1 + {a}_{7}^{2} ) ] ( \frac{{x}^{3}}{6 R} + \frac{{a}_{7} {x}^{2}}{2} + {b}_{7} x + \frac{{h}_{o} x}{2} ) + {f}_{2} ( \frac{{x}^{5}}{10 {R}^{3}} + \frac{{a}_{7} {x}^{4}}{4 {R}^{2}} + \frac{{b}_{7} {x}^{3}}{3 {R}^{2}} + \frac{{h}_{o} {x}^{3}}{6 {R}^{2}} )}{{( {a}_{7} + {b}_{7} x + \frac{{x}^{2}}{2 R} + \frac{{h}_{o}}{2} )}^{2}} - \frac{{τ}_{s 2} ( 1 - \frac{{h}_{y}}{{h}_{o}} ) ( \frac{{a}_{7}^{2} {x}^{3}}{3 R} + \frac{{a}_{7} {b}_{7} {x}^{2}}{2 R} + \frac{{a}_{7} {x}^{4}}{8 {R}^{2}} + \frac{{a}_{7} {h}_{o} {x}^{2}}{4 R} + \frac{{a}_{7} {x}^{4}}{4 {R}^{2}} + \frac{{b}_{7} {x}^{3}}{3 {R}^{2}} + \frac{{h}_{o} {x}^{3}}{6 {R}^{2}} ) + {C}_{7}}{{( {a}_{7} + {b}_{7} x + \frac{{x}^{2}}{2 R} + \frac{{h}_{o}}{2} )}^{2}} + {B}_{7} \qquad ( 28 )$$

According to the stress boundary condition, it can be seen that, when

$$x = 1 = \sqrt{\frac{( 2 R ) ( {H}_{y} + {H}_{r} - {h}_{y} - {h}_{r} )}{2}} = 13.7 mm , x = 1 = \sqrt{\frac{( 2 R ) ( {H}_{y} + {H}_{r} - {h}_{y} - {h}_{r} )}{2}} = 13.7 mm ,$$

which means that tensions of the two metal layers are equal to initial tensions of the two metal layers in a rolling inlet area. In the same way, according to the yield criterion P₇(l)=2kₑᵢ−tᵢ, an integration constant C₇ may be calculated as shown in Formula (29).

$${C}_{7} = ( {k}_{ei} - {t}_{i} - {B}_{7} ) {( {a}_{7} + {b}_{7} 1 + \frac{{1}^{2}}{2 R} + \frac{{h}_{o}}{2} )}^{2} - {f}_{2} ( \frac{{1}^{5}}{10 {R}^{3}} + \frac{{a}_{7} {1}^{4}}{4 {R}^{2}} + \frac{{b}_{7} {1}^{3}}{3 {R}^{2}} + \frac{{h}_{o} {1}^{3}}{6 {R}^{2}} ) + {τ}_{s 2} ( 1 - \frac{{h}_{y}}{{h}_{o}} ) ( \frac{{a}_{7}^{2} {1}^{3}}{3 R} + \frac{{a}_{7} {b}_{7} {1}^{2}}{2 R} + \frac{{a}_{7} {1}^{4}}{8 {R}^{2}} + \frac{{a}_{7} {h}_{o} {1}^{2}}{4 R} + \frac{{a}_{7} {1}^{4}}{4 {R}^{2}} + \frac{{b}_{7} {1}^{3}}{3 {R}^{2}} + \frac{{h}_{o} {1}^{3}}{6 {R}^{2}} ) - [ {f}_{2} - {f}_{1} ( 1 + {a}_{7}^{2} ) ] ( \frac{{1}^{3}}{6 R} + \frac{{a}_{7} {1}^{2}}{2} + {b}_{7} 1 + \frac{{h}_{o} 1}{2} ) ; \qquad ( 29 )$$

$$wherein , {B}_{7} = \frac{{τ}_{s 1} {h}_{y} {a}_{7}}{2 {h}_{o}} ,$$

hₒ=h_{y}+hᵣ, this area is located in the rolling inlet area, a value of a shear yield stress in this area is kₑᵢ, and in this area, an average shear stress on the side surface of the upper copper plate is

$${τ}_{s 1} = \frac{( {f}_{1} + {f}_{3} )}{2} = 79.42 MPa ,$$

and an average shear stress on the side surface of the lower aluminum plate is

$${τ}_{s 2} = \frac{( {f}_{2} + {f}_{3} )}{2} = 71.46 MPa .$$

Stress analysis processes of other differential elements are the same as the principle of the differential element VII, which will not be repeated below, but results are directly presented.

As for the differential element VI (x_{G}<x≤x_{H}), the differential element VI is the fourth-type differential element (the differential element is located on the right side of the first neutral point and in the thinning state), and a rolling stress P₆(x) per unit width of the differential element VI is:

$${P}_{6} ( x ) = {H}_{6} x + {J}_{6} ln \vert {x}^{2} + 2 {Ra}_{6} x + 2 {Rb}_{6} + {Rh}_{0} \vert + \frac{{L}_{6}}{{G}_{6}} ln \vert \frac{x + {Ra}_{6} - {G}_{6}}{x + {Ra}_{6} + {G}_{6}} \vert - 2 {a}_{6} [ {f}_{2} - ( 1 - \frac{{h}_{y}}{{h}_{o}} ) {τ}_{s 2} ] + {C}_{6} ;$$

$$wherein , {H}_{6} = - \frac{2 [ {f}_{2} + ( 1 \frac{{h}_{y}}{{h}_{o}} ) {τ}_{s 2} ]}{R} , {J}_{{6}^{=}} 2 {k}_{e} - 2 {a}_{6} {f}_{2} - {a}_{6} [ {τ}_{s 2} ( 1 - \frac{{h}_{y}}{{h}_{o}} ) + {τ}_{s 1} \frac{{h}_{y}}{{h}_{o}} ] ;$$

L₆=[H₆R(Ra₆²−2b₆−hₒ)+2R(f₂+f₁)(a₆²+1)]/2;

G₆=\sqrt{R(Ra₆²−2b₆−hₒ)}.

A value of a shear yield stress in an area of the differential element VI is kₑ, an average shear stress on the side surface of the upper copper plate is

$${τ}_{s 1} = \frac{( {f}_{1} - {f}_{3} )}{4} = 10.28 MPa ,$$

and an average shear stress on the side surface of the lower aluminum plate is

$${τ}_{s 2} = \frac{( {f}_{2} + {f}_{3} )}{2} = 71.46 MPa .$$

A specific calculation method for an integration constant Ce is as follows:

$${C}_{6} = {P}_{7} ( {x}_{H} ) - {H}_{6} {x}_{H} - {J}_{6} ln \vert {x}_{H}^{2} - 2 {Ra}_{6} {x}_{H} + 2 {Rb}_{6} + {Rh}_{0} \vert - \frac{{L}_{6}}{{G}_{6}} ln \vert \frac{{x}_{H} + {Ra}_{6} - {G}_{6}}{{x}_{H} + {Ra}_{6} + {G}_{6}} \vert + 2 {a}_{6} [ {f}_{2} - ( 1 - \frac{{h}_{y}}{{h}_{o}} ) {τ}_{s 2} ] .$$

As for the differential element V (x_{F}<x≤x_{G}), the differential element V is the second-type differential element (the differential element is located on the right side of the first neutral point and in the thickening state), and a rolling stress P₅(x) per unit width of the differential element V is:

$${P}_{5} ( x ) = {k}_{e} + \frac{[ {f}_{2} - {f}_{1} ( 1 + {a}_{5}^{2} ) ] ( \frac{{x}^{3}}{6 R} + \frac{{a}_{5} {x}^{2}}{2} + {b}_{5} x + \frac{{h}_{o} x}{2} ) + {f}_{2} ( \frac{{x}^{5}}{10 {R}^{3}} + \frac{{a}_{5} {x}^{4}}{4 {R}^{2}} + \frac{{b}_{5} {x}^{3}}{3 {R}^{2}} + \frac{{h}_{o} {x}^{3}}{6 {R}^{2}} )}{{( {a}_{5} + {b}_{5} x + \frac{{x}^{2}}{2 R} + \frac{{h}_{o}}{2} )}^{2}} - \frac{{τ}_{s 2} ( 1 - \frac{{h}_{y}}{{h}_{o}} ) ( \frac{{a}_{5}^{2} {x}^{3}}{3 R} + \frac{{a}_{5} {b}_{5} {x}^{2}}{2 R} + \frac{{a}_{5} {x}^{4}}{8 {R}^{2}} + \frac{{a}_{5} {h}_{o} {x}^{2}}{4 R} + \frac{{a}_{5} {x}^{4}}{4 {R}^{2}} + \frac{{b}_{5} {x}^{3}}{3 {R}^{2}} + \frac{{h}_{o} {x}^{3}}{6 {R}^{2}} ) + {C}_{5}}{{( {a}_{5} + {b}_{5} x + \frac{{x}^{2}}{2 R} + \frac{{h}_{o}}{2} )}^{2}} + {B}_{5} ;$$

$$wherein , {B}_{5} = \frac{{τ}_{s 1} {h}_{y} {a}_{5}}{2 {h}_{o}} ,$$

a value of a shear yield stress in this area is kₑ, and in this area, an average shear stress on the side surface of the upper copper plate is

$${τ}_{s 1} = \frac{( {f}_{1} + {f}_{3} )}{2} = 79.42 MPa ,$$

and an average shear stress on the side surface of the lower aluminum plate is

$${τ}_{s 2} = \frac{( {f}_{2} + {f}_{3} )}{2} = 71.46 MPa .$$

A specific calculation method for an integration constant C₅ is as follows:

$${C}_{5} = ( {P}_{6} ( {x}_{G} ) - {B}_{5} ) {( {a}_{5} + {b}_{5} {x}_{G} + \frac{{x}_{G}^{2}}{2 R} + \frac{{h}_{o}}{2} )}^{2} - [ \text{} {f}_{2} - {f}_{1} ( 1 + {a}_{5}^{2} ) ] ( \frac{{x}_{G}^{3}}{6 R} + \frac{{a}_{5} {x}_{G}^{2}}{2} + {b}_{5} {x}_{G} + \frac{{h}_{o} {x}_{G}}{2} ) + {τ}_{s 2} ( 1 - \frac{{h}_{y}}{{h}_{o}} ) ( \frac{{a}_{5}^{2} {x}_{G}^{3}}{3 R} + \frac{{a}_{5} {b}_{5} {x}_{G}^{2}}{2 R} + \frac{{a}_{5} {x}_{G}^{4}}{8 {R}^{2}} + \frac{{a}_{5} {h}_{o} {x}_{G}^{2}}{4 R} + \frac{{a}_{5} {x}_{G}^{4}}{4 {R}^{2}} + \frac{{b}_{5} {x}_{G}^{3}}{3 {R}^{2}} + \frac{{h}_{o} {x}_{G}^{3}}{6 {R}^{2}} ) - {f}_{2} ( \frac{{x}_{G}^{5}}{10 {R}^{3}} + \frac{{a}_{5} {x}_{G}^{4}}{4 {R}^{2}} + \frac{{b}_{5} {x}_{G}^{3}}{3 {R}^{2}} + \frac{{h}_{o} {x}_{G}^{3}}{6 {R}^{2}} ) .$$

As for the differential element IV (x_{E}<x≤x_{F}), the differential element IV is the fourth-type differential element (the differential element is located on the right side of the first neutral point and in the thinning state), and a rolling stress P₄(x) per unit width of the differential element IV is:

$${P}_{4} ( x ) = {H}_{4} x + {J}_{4} ln \vert {x}^{2} + 2 {Ra}_{4} x + 2 {Rb}_{4} + {Rh}_{0} \vert + \frac{{L}_{4}}{{G}_{4}} ln \vert \frac{x + {Ra}_{4} - {G}_{4}}{x + {Ra}_{4} + {G}_{4}} \vert - 2 {a}_{4} [ {f}_{2} - ( 1 - \frac{{h}_{y}}{{h}_{o}} ) {τ}_{s 2} ] + {C}_{4} ;$$

$$wherein , \\ {H}_{4} = - \frac{2 [ {f}_{2} + ( 1 - \frac{{h}_{y}}{{h}_{o}} ) {τ}_{s 2} ]}{R} , \\ {J}_{4} = 2 {k}_{e} - 2 {a}_{4} {f}_{2} - {a}_{4} [ {τ}_{s 2} ( 1 - \frac{{h}_{y}}{{h}_{o}} ) + {τ}_{s 1} \frac{{h}_{y}}{{h}_{o}} ] ;$$

L₄=[H₄R(Ra₄²−2b₄−hₒ)+2R(f₂+f₁)(a₄²+1)]/2;

G₄=\sqrt{R(Ra₄²−2b₄−hₒ)};

wherein, a value of a shear yield stress in this area is kₑ, and in this area, an average shear stress on the side surface of the upper copper plate is

$${τ}_{s 1} = \frac{( {f}_{1} - {f}_{3} )}{4} = 10.28 MPa ,$$

and an average shear stress on the side surface of the lower aluminum plate is

$${τ}_{s 2} = \frac{( {f}_{2} + {f}_{3} )}{2} = 71.46 MPa .$$

A specific calculation method for an integration constant C₄ is as follows:

$${C}_{4} = {P}_{5} ( {x}_{F} ) - {H}_{4} {x}_{F} - {J}_{4} ln \vert {x}_{F}^{2} - 2 {Ra}_{4} {x}_{F} + 2 {Rb}_{4} + {Rh}_{0} \vert - \frac{{L}_{4}}{{G}_{4}} ln \vert \frac{{x}_{F} + {Ra}_{4} - {G}_{4}}{{x}_{F} + {Ra}_{4} + {G}_{4}} \vert + 2 {a}_{4} [ {f}_{2} - ( 1 - \frac{{h}_{y}}{{h}_{o}} ) {τ}_{s 2} ] .$$

As for the differential element III (x_{D}<x≤x_{E}), the differential element III is the second-type differential element (the differential element is located on the right side of the first neutral point and in the thickening state), and a rolling stress P₃(x) per unit width of the differential element III is:

$${P}_{3} ( x ) = {k}_{e} + \frac{\begin{matrix}[ {f}_{2} - {f}_{1} ( 1 + {a}_{3}^{2} ) ] ( \frac{{x}^{3}}{6 R} + \frac{{a}_{3} {x}^{2}}{2} + {b}_{3} x + \frac{{h}_{o} x}{2} ) + \\ {f}_{2} ( \frac{{x}^{5}}{10 {R}^{3}} + \frac{{a}_{3} {x}^{4}}{4 {R}^{2}} + \frac{{b}_{3} {x}^{3}}{3 {R}^{2}} + \frac{{h}_{o} {x}^{3}}{6 {R}^{2}} )\end{matrix}}{{( {a}_{3} + {b}_{3} x + \frac{{x}^{2}}{2 R} + \frac{{h}_{o}}{2} )}^{2}} - \frac{\begin{matrix}{τ}_{s 2} ( 1 - \frac{{h}_{y}}{{h}_{o}} ) ( \frac{{a}_{3}^{2} {x}^{3}}{3 R} + \frac{{a}_{3} {b}_{3} {x}^{2}}{2 R} + \frac{{a}_{3} {x}^{4}}{8 {R}^{2}} + \\ \frac{{a}_{3} {h}_{o} {x}^{2}}{4 R} + \frac{{a}_{3} {x}^{4}}{4 {R}^{2}} + \frac{{b}_{3} {x}^{3}}{3 {R}^{2}} + \frac{{h}_{o} {x}^{3}}{6 {R}^{2}} ) + {C}_{3}\end{matrix}}{{( {a}_{3} + {b}_{3} x + \frac{{x}^{2}}{2 R} + \frac{{h}_{o}}{2} )}^{2}} + {B}_{3} ;$$

$$wherein , {B}_{3} = \frac{{τ}_{s 1} {h}_{y} {a}_{3}}{2 {h}_{o}} ,$$

hₒ=h_{y}+hᵣ, a value of a shear yield stress in this area is kₑ, and in this area, an average shear stress on the side surface of the upper copper plate is

$${τ}_{s 1} = \frac{( {f}_{1} + {f}_{3} )}{2} = 79.42 MPa ,$$

and an average shear stress on the side surface of the lower aluminum plate is

$${τ}_{s 2} = \frac{( {f}_{2} + {f}_{3} )}{2} = 71.46 MPa .$$

A specific calculation method for an integration constant C₃ is as follows:

$${C}_{3} = ( {P}_{4} ( {x}_{E} ) - {B}_{3} ) - [ {f}_{2} - {f}_{1} ( 1 + {a}_{3}^{2} ) ] ( \frac{{x}_{E}^{3}}{6 R} + \frac{{a}_{3} {x}_{E}^{2}}{2} + {b}_{3} {x}_{E} + \frac{{h}_{o} {x}_{E}}{2} ) + {τ}_{s 2} ( 1 - \frac{{h}_{y}}{{h}_{o}} ) ( \frac{{a}_{3}^{2} {x}_{E}^{3}}{3 R} + \frac{{a}_{3} {b}_{3} {x}_{E}^{2}}{2 R} + \frac{{a}_{3} {x}_{E}^{4}}{8 {R}^{2}} + \frac{{a}_{3} {h}_{o} {x}_{E}^{2}}{4 R} + \frac{{a}_{3} {x}_{E}^{4}}{4 {R}^{2}} + \frac{{b}_{3} {x}_{E}^{3}}{3 {R}^{2}} + \frac{{h}_{o} {x}_{E}^{3}}{6 {R}^{2}} ) - {f}_{2} ( \frac{{x}_{E}^{5}}{10 {R}^{3}} + \frac{{a}_{3} {x}_{E}^{4}}{4 {R}^{2}} + \frac{{b}_{3} {x}_{E}^{3}}{3 {R}^{2}} + \frac{{h}_{o} {x}_{E}^{3}}{6 {R}^{2}} ) .$$

As for the differential element II (x_{N}<x≤x_{D}), the differential element II is the fourth-type differential element (the differential element is located on the right side of the first neutral point and in the thinning state), and a rolling stress P₂(x) per unit width of the differential element II is:

$${P}_{2} ( x ) = {H}_{2} x + {J}_{2} ln \vert {x}^{2} + 2 {Ra}_{2} x + 2 {Rb}_{2} + {Rh}_{0} \vert + \frac{{L}_{2}}{{G}_{2}} ln \vert \frac{x + {Ra}_{2} - {G}_{2}}{x + {Ra}_{2} + {G}_{2}} \vert - 2 {a}_{2} [ {f}_{2} - ( 1 - \frac{{h}_{y}}{{h}_{o}} ) {τ}_{s 2} ] + {C}_{2} ;$$

$$wherein , {H}_{2} = - \frac{2 [ {f}_{2} + ( 1 - \frac{{h}_{y}}{{h}_{o}} ) {τ}_{s 2} ]}{R} , \\ {J}_{{2}^{=}} 2 {k}_{e} - 2 {a}_{2} {f}_{2} - {a}_{2} [ {τ}_{s 2} ( 1 - \frac{{h}_{y}}{{h}_{o}} ) + {τ}_{s 1} \frac{{h}_{y}}{{h}_{o}} ] \\ {L}_{2} = [ {H}_{2} R ( {Ra}_{2}^{2} - 2 {b}_{2} - {h}_{o} ) + 2 R ( {f}_{2} + {f}_{1} ) ( {a}_{2}^{2} + 1 ) ] / 2 ;$$

G₂=\sqrt{R(Ra₂²−2b₂−hₒ)}.

A value of a shear yield stress in this area is kₑ, and in this area, an average shear stress on the side surface of the upper copper plate is

$${τ}_{s 1} = \frac{( {f}_{1} - {f}_{3} )}{4} = 10.28 MPa ,$$

and an average shear stress on the side surface of the lower aluminum plate is

$${τ}_{s 2} = \frac{( {f}_{2} + {f}_{3} )}{2} = 71.46 MPa .$$

A specific calculation method for an integration constant C₂ is as follows:

$${C}_{2} = {P}_{3} ( {x}_{D} ) - {H}_{2} {x}_{D} - {J}_{2} ln \vert {x}_{D}^{2} - 2 {Ra}_{2} {x}_{D} + 2 {Rb}_{2} + {Rh}_{0} \vert - \frac{{L}_{2}}{{G}_{2}} ln \vert \frac{{x}_{D} + {Ra}_{2} - {G}_{2}}{{x}_{D} + {Ra}_{2} + {G}_{2}} \vert + 2 {a}_{2} [ {f}_{2} - ( 1 - \frac{{h}_{y}}{{h}_{o}} ) {τ}_{s 2} ] .$$

As for the differential element I (x_{C}<x≤x_{N}), the differential element I is the third-type differential element (the differential element is located on the left side of the first neutral point and in the thinning state), and a rolling stress P₁(x) per unit width of the differential element I is:

$${P}_{1} ( x ) = {D}_{1} x + {B}_{1} ln \vert {x}^{2} + 2 {Ra}_{1} x + 2 {Rb}_{n} + {Rh}_{0} \vert + \frac{{F}_{1}}{{G}_{1}} ln \vert \frac{x + {Ra}_{1} - {G}_{1}}{x + {Ra}_{1} + {G}_{1}} \vert - 2 {a}_{1} [ {f}_{2} - ( 1 - \frac{{h}_{y}}{{h}_{o}} ) {τ}_{s 2} ] + {C}_{1} ;$$

$$wherein , \\ {D}_{1} = \frac{2 [ {f}_{2} + ( 1 - \frac{{h}_{y}}{{h}_{o}} ) {τ}_{s 2} ]}{R} ; \\ {E}_{1} = 2 {k}_{eo} - 2 {a}_{1} {f}_{2} - {a}_{1} [ {τ}_{s 2} ( 1 - \frac{{h}_{y}}{{h}_{o}} ) + {τ}_{s 1} \frac{{h}_{y}}{{h}_{o}} ] ; \\ {F}_{1} = \frac{[ {D}_{1} R ( {Ra}_{1}^{2} - 2 {b}_{1} - {h}_{o} ) + 2 R ( {f}_{2} - {f}_{1} ) ( {a}_{1}^{2} + 1 ) ]}{2} ;$$

G₁=\sqrt{R(Ra₁²−2b₁−hₒ)};

wherein, this area is located in the rolling outlet area, a value of a shear yield stress in this area is kₑₒ, and in this area, an average shear stress on the side surface of the upper copper plate is

$${τ}_{s 1} = \frac{( {f}_{1} - {f}_{3} )}{4} = 10.28 MPa ,$$

and an average shear stress on the side surface of the lower aluminum plate is

$${τ}_{s 2} = \frac{( {f}_{2} - {f}_{3} )}{4} = 6.29 MPa .$$

A specific calculation method for an integration constant C is as follows:

$${C}_{1} = 2 {k}_{eo} - {t}_{o} - {D}_{1} {x}_{C} - {E}_{1} ln \vert {x}_{{C}^{2}} + 2 {Ra}_{1} {x}_{C} + 2 {Rb}_{1} + {Rh}_{0} \vert - \frac{{F}_{1}}{{G}_{1}} ln \vert \frac{{x}_{C} + {Ra}_{1} - {G}_{1}}{{x}_{C} + {Ra}_{1} + {G}_{1}} \vert + 2 {a}_{1} [ {f}_{2} - ( 1 - \frac{{h}_{y}}{{h}_{o}} ) {τ}_{s 2} ] .$$

Subsequently, the position of the first neutral point is determined according to the stress boundary condition, and the rolling force per unit width of the whole rolling deformation area is solved after obtaining the position coordinates of each neutral point.

In the solution process, it is assumed that the neutral point of the flat roller is between the differential element I and the differential element II, that is, x_{N}∈[x_{C}, x_{D}], it may be judged through a stress boundary that an assumed position area is inappropriate, and the position x_{N}∈[x_{E}, x_{F}], x_{N}=5.2455 mm of the neutral point of the flat roller may be obtained after assuming again.

Subsequently, the rolling force P per unit width of the whole rolling deformation area may be calculated and obtained as follows:

$${P}^{′} = {\int }_{{x}_{C}}^{{x}_{D}} {P}_{1} ( x ) + {\int }_{{x}_{D}}^{{x}_{E}} {P}_{2} ( x ) + {\int }_{{x}_{E}}^{{x}_{N}} {P}_{3} ( x ) + {\int }_{{x}_{N}}^{{x}_{F}} {P}_{4} ( x ) + {\int }_{{x}_{F}}^{{x}_{G}} {P}_{5} ( x ) + {\int }_{{x}_{G}}^{{x}_{H}} {P}_{6} ( x ) + {\int }_{{x}_{H}}^{1} {P}_{7} ( x ) = 6.77 MPa .$$

Finally, according to a width B of a clad plate blank combined with the rolling force P per unit width of the whole deformation are calculated in the step 4.4, the rolling force P_{target}=BP′=50×6.77=338.5 kN of the whole deformation area in a state that the outlet position is the corrugation trough position is calculated and obtained. It may be obtained by the same method that, in a state that the outlet position is the front corrugation waist midpoint position, P_{target}=301.2 kN; in a state that the outlet position is the corrugation peak position, P_{target}=289.7 kN; and in a state that the outlet position is the back corrugation waist midpoint position, P_{target}=301.8 kN. A dynamic rolling force in the whole rolling process is obtained by the above calculation method.

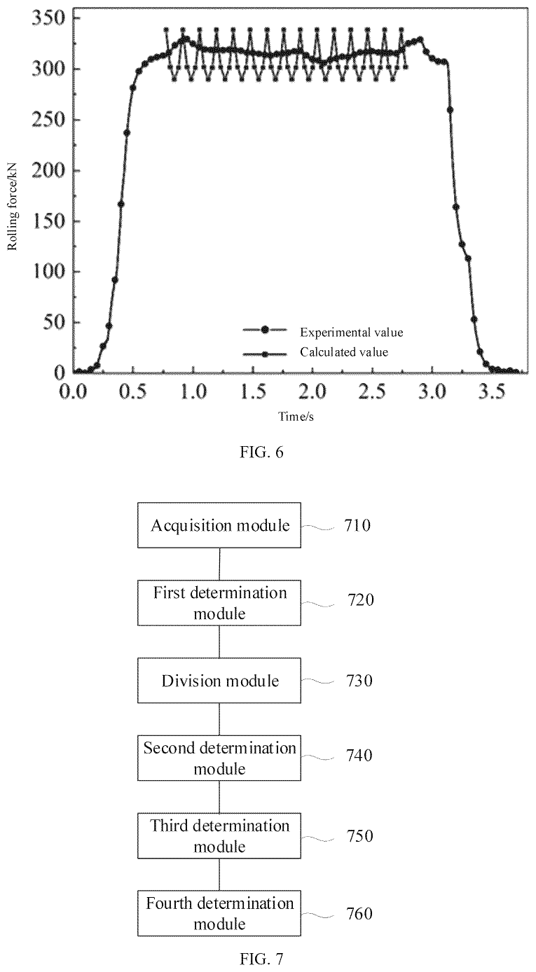

With reference to FIG. 6, in order to confirm the accuracy and reliability of the determination method provided by the present invention, rolling force data are collected in real time by a force sensor and transmitted to a computer in real time through a signal collector, thereby entering a stable rolling stage. An experimental value and a model predicted value of average rolling force are 323.5 kN and 314.1 kN respectively, and an error between the predicted average rolling force and the experimental value is within 2.9%. It can be seen that the rolling force in corrugated rolling of the metal clad plate predicted by the method provided by the present invention has higher accuracy, and the error is within an allowable range, so that the method can be well applied to actual production.

An apparatus for determining a rolling force in a corrugated roller rolling technology provided by the present invention is described below, and the apparatus for determining the rolling force in the corrugated roller rolling technology described below and the method for determining the rolling force in the corrugated roller rolling technology described above may be reciprocally referential correspondingly.

As shown in FIG. 7, the embodiment of the present invention further provides an apparatus for determining a rolling force in a corrugated roller rolling technology, which is used for implement the method for determining the rolling force in the corrugated roller rolling technology in any embodiment above. The apparatus for determining the rolling force in the corrugated roller rolling technology may comprise:
an acquisition module 710 configured for acquiring technological parameters in a rolling process of a metal clad plate; wherein the technological parameters comprise at least a width of the metal clad plate;
a first determination module 720 configured for determining a first neutral point corresponding to a flat roller and a second neutral point corresponding to a corrugated roller;
a division module 730 configured for, based on the first neutral point and the second neutral point, dividing a deformation area of the metal clad plate to obtain a plurality of differential elements; wherein the deformation area is a clad plate area in which the metal clad plate makes contact with the flat roller; a second determination module 740 configured for, based on the technological parameters, determining critical information of each differential element; wherein the critical information comprises critical coordinates and shape parameters;
a third determination module 750 configured for, based on a type and the critical information of each differential element, determining and obtaining a rolling force per unit width corresponding to the deformation area by a differential equation of force equilibrium; and
a fourth determination module 760 configured for, based on the rolling force per unit width and the width of the metal clad plate, determining a rolling force in rolling of the metal clad plate by the corrugated roller.

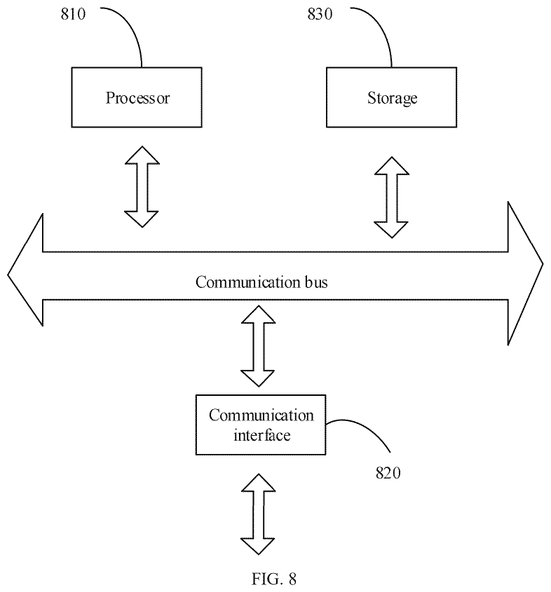

As shown in FIG. 8, the embodiment of the present invention further provides an electronic device, and the electronic device may comprise a processor 810, a communication interface 820, a storage 830 and a communication bus; wherein, the processor 810, the communication interface 820 and the storage 830 communicate with each other through the communication bus. A computer program executable by the processor 810 is stored in the storage 830; and when the computer program is operated in the processor 810, the method for determining the rolling force in the corrugated roller rolling technology according to any embodiment above may be executed.

Although the present invention is described herein with reference to the embodiments, in the process of implementing the present invention sought to be protected, those skilled in the art may understand and realize other variations of the disclosed embodiments by reviewing the drawings, the disclosed contents and the appended claims. In the claims, the term “comprise” does not exclude other components or steps, and the term “a” or “one” does not exclude the case of being multiple. A single processor or other units can realize several functions recited in the claims. Certain measures are recorded in dependent claims which are different from each other, which does not mean that these measures cannot be combined to achieve good effects.

Although the present invention is described with reference to specific features and embodiments thereof, it is obvious that various modifications and combinations may be made without departing from the spirit and scope of the present invention. Accordingly, the specification and the drawings are merely exemplary illustrations of the present invention as defined by the appended claims, and are deemed to cover any and all modifications, variations, combinations or equivalents within the scope of the present invention. Obviously, those skilled in the art may make various modifications and variations to the present invention without departing from the spirit and scope of the present invention. Therefore, if these modifications and variations of the present invention fall within the scope of the claims of the present invention and their equivalents, the present invention is also intended to include these modifications and variations.

We claim:

1. A method for determining a rolling force in a corrugated roller rolling technology, comprising the following steps of:
acquiring technological parameters in a rolling process of a metal clad plate; wherein the technological parameters comprise at least a width of the metal clad plate;
determining a first neutral point corresponding to a flat roller and a second neutral point corresponding to a corrugated roller;
based on the first neutral point and the second neutral point, dividing a deformation area of the metal clad plate to obtain a plurality of differential elements; wherein the deformation area is a clad plate area in which the metal clad plate makes contact with the flat roller and the metal clad plate makes contact with the corrugated roller;
based on the technological parameters, determining critical information of each differential element; wherein the critical information comprises critical coordinates and shape parameters;
based on a type and the critical information of each differential element, determining and obtaining a rolling force per unit width corresponding to the deformation area by a differential equation of force equilibrium; and
based on the rolling force per unit width and the width of the metal clad plate, determining a rolling force in rolling of the metal clad plate by the corrugated roller;
wherein the technological parameters further comprise a length of a corrugated clad plate, an upper surface equation of the corrugated clad plate in contact with the corrugated roller and a lower surface equation of the corrugated clad plate in contact with the flat roller; and the corrugated clad plate is a rolled metal clad plate;
the upper surface equation is:
$$\{ \begin{matrix}{y}_{1} ( x ) = \frac{{h}_{o}}{2} - \frac{4 {λ}_{H}}{{λ}_{S}^{2}} ( x - ( i {λ}_{S} + \frac{{λ}_{S}}{2} ) ) ( x - ( i {λ}_{S} + {λ}_{S} ) ) , \\ i ∈ Z , x ∈ [ i {λ}_{S} , i {λ}_{S} + \frac{{λ}_{S}}{2} ] \\ {y}_{2} ( x ) = \frac{{h}_{o}}{2} + \frac{4 {λ}_{H}}{{λ}_{S}^{2}} ( x - ( i {λ}_{S} + {λ}_{S} ) ) ( x - ( i {λ}_{S} + \frac{3 {λ}_{S}}{2} ) ) , \\ i ∈ Z , x ∈ [ i {λ}_{S} + \frac{{λ}_{S}}{2} , ( i + 1 ) {λ}_{S} ]\end{matrix}$$
the lower surface equation is:
$${y}_{3} ( x ) = - \frac{{h}_{o}}{2} , x ∈ [ 0 , L ] ;$$
wherein, hₒ=h_{y}+hᵣ, L is the length of the corrugated clad plate; λ_{H} is an amplitude of corrugation in the corrugated roller, λ_{S} is a length of one cycle of corrugation in the corrugated roller; and Z represents a positive integer;
the method for determining the rolling force further comprises extracting and obtaining the amplitude of corrugation in the corrugated roller and the length of one cycle of corrugation in the corrugated roller from the upper surface equation;
before the step of, based on the type and the critical information of each differential element, determining and obtaining the rolling force per unit width corresponding to the deformation area by the differential equation of force equilibrium, the method further comprises: when the differential element is located on a left side of the first neutral point and in a thickening state, determining the differential element as a first-type differential element; when the differential element is located on a right side of the first neutral point and in the thickening state, determining the differential element as a second-type differential element; when the differential element is located on the left side of the first neutral point and in a thinning state, determining the differential element as a third-type differential element; and when the differential element is located on the right side of the first neutral point and in the thinning state, determining the differential element as a fourth-type differential element;
the metal clad plate comprises a hard metal layer and a soft metal layer; the step of, based on the type and the critical information of each differential element, determining and obtaining the rolling force per unit width corresponding to the deformation area by the differential equation of force equilibrium, comprises:
determining a first contact friction stress between the hard metal layer and the corrugated roller; determining a second contact friction stress between the soft metal layer and the flat roller; and determining a third contact friction stress between the hard metal layer and the soft metal layer;
according to the type of each differential element, based on the first contact friction stress, the second contact friction stress and the third contact friction stress, calculating and obtaining a first average shear stress corresponding to the hard metal layer in each differential element and a second average shear stress corresponding to the soft metal layer in each differential element;
based on the type of each differential element, substituting both of the first average shear stress and the second average shear stress corresponding to each differential element into the differential equation of force equilibrium, and according to a stress boundary condition and a yield condition, deriving and obtaining the rolling stress per unit width corresponding to the differential element; and based on the critical information, performing integration and summation on rolling stresses per unit width of all differential elements in the deformation area to obtain the rolling force per unit width;
the step of, according to the type of each differential element, based on the first contact friction stress, the second contact friction stress and the third contact friction stress, calculating and obtaining the first average shear stress corresponding to the hard metal layer in each differential element and the second average shear stress corresponding to the soft metal layer in each differential element, comprises:
as for the first-type differential element, substituting the first contact friction stress and the third contact friction stress into a formula:
$${τ}_{s 1} = \frac{{f}_{1} + {f}_{3}}{2}$$
calculating and obtaining the first average shear stress; wherein τₛ₁ is the first average shear stress; f₁ is the first contact friction stress; and f₃ is the third contact friction stress;
as for the first-type differential element, substituting the second contact friction stress and the third contact friction stress into a formula:
$${τ}_{s 2} = \frac{{f}_{2} - {f}_{3}}{4}$$
calculating and obtaining the second average shear stress; wherein τₛ₂ is the second average shear stress; and f₂ is the second contact friction stress;
as for the second-type differential element, substituting the first contact friction stress and the third contact friction stress into a formula:
$${τ}_{s 1} = \frac{{f}_{1} + {f}_{3}}{2}$$
calculating and obtaining the first average shear stress;
as for the second-type differential element, substituting the second contact friction stress and the third contact friction stress into a formula:
$${τ}_{s 2} = \frac{{f}_{2} + {f}_{3}}{2}$$
calculating and obtaining the second average shear stress;
as for the third-type differential element, substituting the first contact friction stress and the third contact friction stress into a formula:
$${τ}_{s 1} = \frac{{f}_{1} - {f}_{3}}{4}$$
calculating and obtaining the first average shear stress;
as for the third-type differential element, substituting the second contact friction stress and the third contact friction stress into a formula:
$${τ}_{s 2} = \frac{{f}_{2} - {f}_{3}}{4}$$
calculating and obtaining the second average shear stress;
as for the fourth-type differential element, substituting the first contact friction stress and the third contact friction stress into a formula:
$${τ}_{s 1} = \frac{{f}_{1} - {f}_{3}}{4}$$
calculating and obtaining the first average shear stress; and
as for the fourth-type differential element, substituting the second contact friction stress and the third contact friction stress into a formula:
$${τ}_{s 2} = \frac{{f}_{2} + {f}_{3}}{2}$$
calculating and obtaining the second average shear stress.

2. The method for determining the rolling force in the corrugated roller rolling technology according to claim 1, wherein the technological parameters further comprise a first friction coefficient, a second friction coefficient and a third friction coefficient;
the step of determining the first contact friction stress between the hard metal layer and the corrugated roller, comprises:
substituting the first friction coefficient into a formula:
f₁=2m₁*k₁
calculating and obtaining the first contact friction stress; wherein, m₁ is the first friction coefficient;
the step of determining the second contact friction stress between the soft metal layer and the flat roller, comprises:
substituting the second friction coefficient into a formula:
f₂−2m₂*k₂
calculating and obtaining the second contact friction stress; wherein, m₂ is the second friction coefficient;
the step of determining the third contact friction stress between the hard metal layer and the soft metal layer, comprises:
substituting the third friction coefficient into a formula:
f₃=2m₃*kₑ
calculating and obtaining the third contact friction stress; wherein, m₃ is the third friction coefficient;
wherein,
$${k}_{1} = \frac{{σ}_{y}}{\sqrt{3}} ; \\ {k}_{2} = \frac{{σ}_{r}}{\sqrt{3}} ; \\ {k}_{e} = \frac{{k}_{ei} + {k}_{eo}}{2} ; \\ {k}_{ei} = \frac{{H}_{y}}{{H}_{y} + {H}_{r}} * {k}_{1} + \frac{{H}_{r}}{{H}_{y} + {H}_{r}} * {k}_{2} \\ {k}_{eo} = \frac{{h}_{y}}{{h}_{y} + {h}_{r}} * {k}_{1} + \frac{{h}_{r}}{{h}_{y} + {h}_{r}} * {k}_{2}$$
σ_{y} is a deformation resistance of the hard metal layer; and σᵣ is a deformation resistance of the soft metal layer;
Hᵣ is an inlet thickness of the soft metal layer; and hᵣ is an outlet thickness of the soft metal layer; and
H_{y} is an inlet thickness of the hard metal layer; and h_{y} is an outlet thickness of the hard metal layer.

3. The method for determining the rolling force in the corrugated roller rolling technology according to claim 2, wherein the technological parameters further comprise an equivalent rolling radius corresponding to the corrugated roller and the flat roller together;
the step of, based on the technological parameters, determining the critical information of each differential element, comprises:
substituting the equivalent rolling radius into a formula:
$${x}_{n} = ( R + {λ}_{H} ) * sin ( \frac{n π}{M} )$$
calculating and obtaining a critical abscissa; wherein, xₙ is the critical abscissa; R is the equivalent rolling radius; M is a number of corrugations in the corrugated roller; and n represents an n^{th} differential element;
substituting the equivalent rolling radius into a formula:
$${y}_{n} = R + \frac{{h}_{0}}{2} - ( R \pm {λ}_{H} ) * sin ( \frac{n π}{M} ) * cos ( \frac{n π}{M} )$$
calculating and obtaining a critical ordinate; wherein, yₙ is the critical ordinate; h₀ is an outlet thickness of the metal clad plate;
by adopting the following formula:
$${a}_{n} = \frac{{y}_{n + 1} - {y}_{n}}{{x}_{n + 1} - {x}_{n}}$$
calculating and obtaining a first shape parameter; wherein aₙ is the first shape parameter; and
by adopting the following formula:
bₙ=yₙ₊₁−aₙ*xₙ₊₁
calculating and obtaining a second shape parameter; wherein bₙ is the second shape parameter.

4. The method for determining the rolling force in the corrugated roller rolling technology according to claim 3, wherein the step of, based on the critical information, performing integration and summation on the rolling stresses per unit width of all differential elements in the deformation area to obtain the rolling force per unit width, comprises:
based on the critical information, by adopting the following formula:
$$P ’ = {\sum }_{n}^{U} {\int }_{{x}_{n}}^{{x}_{n + 1}} {P}_{n} ( x )$$
calculating and obtaining the rolling force per unit width; wherein, P is the rolling force per unit width; Pₙ(x) is a rolling stress per unit width of the n^{th} differential element; and U is a total number of differential elements.

5. An apparatus for determining a rolling force in a corrugated roller rolling technology, comprising:
an acquisition module configured for acquiring technological parameters in a rolling process of a metal clad plate; wherein the technological parameters comprise at least a width of the metal clad plate;
a first determination module configured for determining a first neutral point corresponding to a flat roller and a second neutral point corresponding to a corrugated roller;
a division module configured for, based on the first neutral point and the second neutral point, dividing a deformation area of the metal clad plate to obtain a plurality of differential elements; wherein the deformation area is a clad plate area in which the metal clad plate makes contact with the flat roller;
a second determination module configured for, based on the technological parameters, determining critical information of each differential element; wherein the critical information comprises critical coordinates and shape parameters;
a third determination module configured for, based on a type and the critical information of each differential element, determining and obtaining a rolling force per unit width corresponding to the deformation area by a differential equation of force equilibrium; and
a fourth determination module configured for, based on the rolling force per unit width and the width of the metal clad plate, determining a rolling force in rolling of the metal clad plate by the corrugated roller;
wherein the technological parameters further comprise a length of a corrugated clad plate, an upper surface equation of the corrugated clad plate in contact with the corrugated roller and a lower surface equation of the corrugated clad plate in contact with the flat roller; and the corrugated clad plate is a rolled metal clad plate;
the upper surface equation is:
$$\{ \begin{matrix}{y}_{1} ( x ) = \frac{{h}_{o}}{2} - \frac{4 {λ}_{H}}{{{λ}_{S}}^{2}} ( x - ( i {λ}_{S} + \frac{{λ}_{S}}{2} ) ) ( x - ( i {λ}_{S} + {λ}_{S} ) ) , i ∈ Z , x ∈ [ i {λ}_{S} , i {λ}_{S} + \frac{{λ}_{S}}{2} ] \\ {y}_{2} ( x ) = \frac{{h}_{o}}{2} + \frac{4 {λ}_{H}}{{{λ}_{S}}^{2}} ( x - ( i {λ}_{S} + {λ}_{S} ) ) ( x - ( i {λ}_{S} + \frac{3 {λ}_{S}}{2} ) ) , i ∈ Z , x ∈ [ i {λ}_{S} + \frac{{λ}_{S}}{2} , ( i + 1 ) {λ}_{S} ]\end{matrix}$$
the lower surface equation is:
$${y}_{3} ( x ) = - \frac{{h}_{0}}{2} , x ∈ [ 0 , L ] ;$$
wherein, hₒ=h_{y}+hᵣ, L is the length of the corrugated clad plate; λ_{H} is an amplitude of corrugation in the corrugated roller, λ_{S} is a length of one cycle of corrugation in the corrugated roller; and Z represents a positive integer;
the method for determining the rolling force further comprises extracting and obtaining the amplitude of corrugation in the corrugated roller and the length of one cycle of corrugation in the corrugated roller from the upper surface equation;
before the step of, based on the type and the critical information of each differential element, determining and obtaining the rolling force per unit width corresponding to the deformation area by the differential equation of force equilibrium, the method further comprises: when the differential element is located on a left side of the first neutral point and in a thickening state, determining the differential element as a first-type differential element; when the differential element is located on a right side of the first neutral point and in the thickening state, determining the differential element as a second-type differential element; when the differential element is located on the left side of the first neutral point and in a thinning state, determining the differential element as a third-type differential element; and when the differential element is located on the right side of the first neutral point and in the thinning state, determining the differential element as a fourth-type differential element;
the metal clad plate comprises a hard metal layer and a soft metal layer; the step of, based on the type and the critical information of each differential element, determining and obtaining the rolling force per unit width corresponding to the deformation area by the differential equation of force equilibrium, comprises:
determining a first contact friction stress between the hard metal layer and the corrugated roller; determining a second contact friction stress between the soft metal layer and the flat roller; and determining a third contact friction stress between the hard metal layer and the soft metal layer;
according to the type of each differential element, based on the first contact friction stress, the second contact friction stress and the third contact friction stress, calculating and obtaining a first average shear stress corresponding to the hard metal layer in each differential element and a second average shear stress corresponding to the soft metal layer in each differential element;
based on the type of each differential element, substituting both of the first average shear stress and the second average shear stress corresponding to each differential element into the differential equation of force equilibrium, and according to a stress boundary condition and a yield condition, deriving and obtaining the rolling stress per unit width corresponding to the differential element; and based on the critical information, performing integration and summation on rolling stresses per unit width of all differential elements in the deformation area to obtain the rolling force per unit width;
the step of, according to the type of each differential element, based on the first contact friction stress, the second contact friction stress and the third contact friction stress, calculating and obtaining the first average shear stress corresponding to the hard metal layer in each differential element and the second average shear stress corresponding to the soft metal layer in each differential element, comprises:
as for the first-type differential element, substituting the first contact friction stress and the third contact friction stress into a formula:
$${τ}_{s 1} = \frac{{f}_{1} + {f}_{3}}{2}$$
calculating and obtaining the first average shear stress; wherein τₛ₁ is the first average shear stress; f₁ is the first contact friction stress; and f₃ is the third contact friction stress;
as for the first-type differential element, substituting the second contact friction stress and the third contact friction stress into a formula:
$${τ}_{s 2} = \frac{{f}_{2} + {f}_{3}}{4}$$
calculating and obtaining the second average shear stress; wherein τₛ₂ is the second average shear stress; and f₂ is the second contact friction stress;
as for the second-type differential element, substituting the first contact friction stress and the third contact friction stress into a formula:
$${τ}_{s 1} = \frac{{f}_{1} + {f}_{3}}{2}$$
calculating and obtaining the first average shear stress;
as for the second-type differential element, substituting the second contact friction stress and the third contact friction stress into a formula:
$${τ}_{s 2} = \frac{{f}_{2} + {f}_{3}}{2}$$
calculating and obtaining the second average shear stress;
as for the third-type differential element, substituting the first contact friction stress and the third contact friction stress into a formula:
$${τ}_{s 1} = \frac{{f}_{1} - {f}_{3}}{4}$$
calculating and obtaining the first average shear stress;
as for the third-type differential element, substituting the second contact friction stress and the third contact friction stress into a formula:
$${τ}_{s 2} = \frac{{f}_{2} - {f}_{3}}{4}$$
calculating and obtaining the second average shear stress;
as for the fourth-type differential element, substituting the first contact friction stress and the third contact friction stress into a formula:
$${τ}_{s 1} = \frac{{f}_{1} - {f}_{3}}{4}$$
calculating and obtaining the first average shear stress; and
as for the fourth-type differential element, substituting the second contact friction stress and the third contact friction stress into a formula:
$${τ}_{s 2} = \frac{{f}_{2} + {f}_{3}}{2}$$
calculating and obtaining the second average shear stress.

6. An electronic device, comprising a processor, a communication interface, a storage and a communication bus; wherein, the processor, the communication interface and the storage communicate through the communication bus; a computer program executable by the processor is stored in the storage; and when the computer program is operated in the processor, the method for determining the rolling force in the corrugated roller rolling technology according to claim 1 is executed.
